(19) United States
(12) Patent Application Publication
(10) Pub. No.: US 2026/0058805 A1
(43) Pub. Date: Feb. 26, 2026

(54) METHODS AND PROCEDURES FOR A ONE-WAY QUANTUM CHANNEL AUTHENTICATION FOR SECURE QUANTUM COMMUNICATION

(71) Applicant: EigenQ, Inc., Columbia, MD (US)

(72) Inventors: José R. Rosas-Bustos, Columbia, MD (US); Jesse Van Griensven Thé, Columbia, MD (US); Mark Pecen, Columbia, MD (US); Roydon Fraser, Columbia, MD (US)

(21) Appl. No.: 19/303,070

(22) Filed: Aug. 18, 2025

Related U.S. Application Data
(60) Provisional application No. 63/685,917, filed on Aug. 22, 2024.
(60) Provisional application No. 63/686,262, filed on Aug. 23, 2024.

(51) Int. Cl. H04L 9/08; H04L 9/32

(52) U.S. Cl. CPC H04L 9/0858; H04L 9/32

(57) ABSTRACT

The present technology pertains to systems and methods for one-way authentication of quantum channels. A transmitter generates an entangled quantum state comprising a first state and a second state, modulates the second state according to a clock-synchronized pattern, and transmits it through a quantum channel to a receiver. The first state is retained and measured at the transmitter to extract quantum-state information. Authentication is performed based on this information, without requiring feedback from the receiver. The quantum-state information may be derived using quadrature measurements, Gaussian tomography, or other statistical analyses to detect whether the second state underwent irreversible interactions such as eavesdropping or decoherence. The system enables secure unidirectional quantum authentication, reduces protocol complexity, and supports real-time anomaly detection. It is compatible with continuous-variable quantum states, quantum key distribution (QKD), and scalable communication architectures.

### CROSS-REFERENCE TO RELATED APPLICATIONS

This application claims priority to and the benefit of U.S. provisional application No. 63/685,917, filed on Aug. 22, 2024, which is expressly incorporated by reference herein in its entirety. This application also claims priority to and the benefit of U.S. provisional application No. 63/686,262, filed on Aug. 23, 2024, which is expressly incorporated by reference herein in its entirety.

### BACKGROUND

Quantum Key Distribution (QKD) protocols have been developed to enable secure communication based on the fundamental principles of quantum mechanics. Foundational QKD schemes include the Bennett and Brassard 1984 (BB84) protocol, the Ekert 1991 (E91) protocol, and the Bennett-Brassard-Mermin 1992 (BBM92) protocol. These protocols can involve either discrete-variable quantum states or entangled qubit pairs and use properties such as the no-cloning theorem to detect the presence of an eavesdropper. While these techniques have advanced the state of secure communications, they generally require a classical post-processing phase involving key sifting, error correction, and privacy amplification, all of which introduce overhead and reliance on classical feedback channels.

The BB84 protocol encodes key bits in the polarization of photons and relies on randomly chosen measurement bases to detect interception. However, BB84's dependence on basis reconciliation via classical communication imposes limitations on its scalability and throughput. The BBM92 protocol builds upon BB84 by utilizing entangled photon pairs, but it retains similar structural constraints, including the necessity of a classical communication channel for post-measurement coordination. The E91 protocol, proposed by Artur Ekert, leverages entangled qubits and Bell inequality violations to ensure security, providing a more theoretically grounded approach to eavesdropping detection. Nevertheless, E91 also requires significant classical messaging and complex entanglement distribution infrastructure.

Additionally, continuous-variable QKD (CV-QKD) protocols have been proposed, including Gaussian-Modulated Coherent States (GMCS) and Continuous-Variable Squeezed States (CVSS) protocols, which encode quantum information in the quadrature amplitudes of coherent or squeezed optical fields. However, these systems still depend on classical post-processing steps and remain vulnerable to attacks on both the quantum and classical portions of the communication infrastructure.

As quantum communication technologies evolve toward the quantum internet and other scalable architectures, there remains a need for quantum protocols that minimize reliance on classical messaging, enable unidirectional authentication, and provide resilience to environmental noise and eavesdropping.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates a block diagram of an example of a quantum communications system in accordance with some embodiments.

FIG. 2 illustrates an example of modulating quantum pings (QPings) in accordance with some embodiments.

FIG. 3 illustrates a flow diagram of an example of a method for providing secure communications using a quantum communications system in accordance with some embodiments.

FIG. 4 illustrates a block diagram of an example of a computing device, in accordance with some embodiments.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

### Overview

Conventional quantum key distribution (QKD) protocols such as BB84, BBM92, and E91 rely heavily on two-way authentication and classical communication to establish secure channels. While effective, these approaches introduce challenges including vulnerability to man-in-the-middle (MITM) and denial-of-service (DoS) attacks, operational complexity due to classical post-processing, and scalability constraints in large quantum networks. The reliance on reciprocal communication increases both the technical burden and the potential attack surface, hindering deployment in high-throughput or latency-sensitive environments.

The One-Way Quantum Channel Authentication method described herein addresses these issues by eliminating the need for reciprocal communication. Using synchronized clocks between a transmitter and receiver, the system transmits one half of an entangled quantum state (e.g., a qumode) through a quantum channel, while retaining the other half at the transmitter. The retained half is measured after the transmission event to detect any disturbances, allowing the transmitter to authenticate the integrity of the channel without requiring feedback or interaction from the receiver. This architecture improves security, reduces overhead, and enhances compatibility with large-scale quantum networks.

According to certain non-limiting examples, the systems and methods disclosed herein provide a secure, one-way authentication mechanism for quantum channels. This is achieved by analyzing quantum-state information derived from the transmitter-retained half of an entangled pair. Because any unauthorized interaction with the transmitted half (such as measurement or environmental decoherence) irreversibly alters the state of the retained half, the transmitter can unilaterally assess whether the channel was compromised during transmission.

The unidirectional nature of this process dramatically reduces the attack surface compared to protocols requiring reciprocal quantum or classical signaling. It mitigates threats such as MITM and DoS attacks, which often exploit the necessity of handshake or feedback phases. By relying exclusively on quantum correlations and synchronized local operations, the system ensures that authentication is tied directly to the physics of the channel and not to externally communicated trust assumptions.

According to certain non-limiting examples, the systems and methods disclosed herein streamline quantum authentication by reducing protocol complexity and increasing efficiency. Traditional QKD systems require multiple rounds of classical communication for basis reconciliation, error correction, and key sifting, all of which consume bandwidth and processing time. These operations are particularly burdensome in constrained or real-time environments.

The systems and methods disclosed herein avoid these complications by using synchronized modulation patterns that eliminate the need for classical reconciliation. The transmitter dynamically modulates each transmitted quantum state according to a deterministic pattern shared via synchronized clocks. The receiver, using the same clock-derived pattern, can decode the incoming quantum states directly. As a result, key material can be distilled with little or no post-processing, enabling higher throughput and lower latency than reciprocal QKD approaches.

According to certain non-limiting examples, the systems and methods disclosed herein enhance the scalability and robustness of quantum communications. In large-scale quantum networks, maintaining bidirectional communication across many links becomes increasingly difficult. The one-way authentication method disclosed herein supports scalable architectures by minimizing communication dependencies and simplifying network topologies.

Robustness is further improved through the use of entangled near-vacuum qumodes, which are inherently difficult to intercept without detection due to their low photon numbers and quantum uncertainty. Additionally, the transmitter performs real-time anomaly detection by analyzing the statistical purity and fidelity of retained quantum states. These capabilities allow the system to operate securely even in the presence of noise, loss, or active adversaries, making it suitable for both terrestrial and satellite-based quantum networks.

The One-Way Quantum Channel Authentication method provides several advantages over other protocols. It delivers secure, unidirectional authentication by leveraging the statistical properties of entangled quantum states, without requiring return transmissions or classical negotiation. This reduces protocol complexity and enables covert or low-latency deployments.

Furthermore, the method includes integrated real-time anomaly detection through local measurement of the retained half of each entangled pair. The system can identify quantum channel disturbances caused by eavesdropping or environmental decoherence with high sensitivity. Finally, the approach is compatible with existing and emerging quantum technologies, including continuous-variable states, quantum repeaters, and quantum memories. Its low operational overhead and adaptability to various platforms make it a strong candidate for deployment in next-generation quantum internet infrastructure.

### Example Embodiments

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

The disclosed technology addresses the need in the art for a secure quantum communication systems and methods that more adaptability and robustness. Further, the systems and methods disclosed herein have the several benefit of being able to seamlessly integrate with new quantum technologies, being able to leverage current infrastructure, providing higher throughput, and offering enhanced security features. The systems and methods disclosed herein can provide these improvements by using dynamic modulation techniques, seed functionality for traffic decryption, and compatibility with various classical and quantum technologies, thus representing an advancement in the field.

Existing QKD systems face several challenges that are at least partially overcome by the. systems and methods disclosed herein. For example, current QKD protocols, such as BB84, E91, BBM92, GMCS, and CVSS, exhibit several limitations that hinder their scalability and practical deployment. These several limitations include: (1) scalability issues; (2) security vulnerabilities; (3) integration challenges; (4) efficiency constraints; and (5) implementation complexity.

Regarding scalability issues, existing QKD and Quantum Communication protocols (“protocols”) depend on extensive classical communication for authentication, data transmission, key sifting and post-processing, which imposes a bottleneck on the overall communication process. This dependency limits the scalability of these protocols for large-scale quantum networks. Further, the need for robust error correction and privacy amplification mechanisms adds complexity and reduces the efficiency of key generation, making it difficult to scale up for extensive networks.

Regarding security vulnerabilities, current protocols are vulnerable to various attacks, including side-channel attacks, Denial of Service (DoS) attacks, and cloning or tempering attacks on the classical channel. These vulnerabilities compromise the security and reliability of quantum communication. Further, many existing protocols lack explicit mechanisms for real-time anomaly detection that rely 100% on the quantum channel, making them less robust against potential security breaches and performance issues.

Regarding integration challenges, compatibility with Quantum Technologies. Existing protocols often need to be more compatible with emerging quantum technologies, such as quantum repeaters, quantum memory, and quantum computing. Integration capability is necessary for the development of a cohesive Quantum Internet infrastructure. Further, current protocols face challenges in seamlessly integrating with quantum teleportation and repeater technologies, which are essential for long-distance quantum communication.

Regarding efficiency constraints, throughput Limitations. Traditional protocols typically suffer from low data throughput, limiting their practical application in high-demand environments. The need for continuous key generation and distribution can slow down the communication process. Further, existing protocols do not adequately support dynamic adaptation to varying network conditions and hardware capabilities, which is crucial for maintaining optimal performance in a dynamic quantum network environment.

Regarding implementation complexity, implementing current protocols depend on sophisticated and often expensive hardware and software components, hindering widespread adoption. Further, the operational complexity of setting up and maintaining secure quantum communication channels using existing protocols can be prohibitively high for many practical applications.

The systems and methods disclosed herein can provide several improvements, including: (1) enhanced scalability; (2) improved security; (3) seamless integration with quantum technologies; (4) higher throughput; (5) dynamic adaptation; (6) reduced complexity and cost; (7) a future-proof design; (8) a hybrid approach for dual use; and (9) quantum encoding.

Regarding enhanced scalability, a Quantum Internet depends on a protocol that can efficiently scale to support vast, interconnected networks. The systems and methods disclosed herein eliminate the dependence on classical communication in key sifting, and the systems and methods disclosed herein can use a streamlined key generation process that enhances scalability.

Regarding improved security, with increasing threats from advanced cyber-attacks, there is a paramount need for a protocol that offers superior security features. The systems and methods disclosed herein can be designed to resist side-channel, DoS, and cloning attacks, providing a more secure communication framework. Further, teal-time anomaly detection mechanisms within the systems and methods disclosed herein to provide prompt identification and mitigation of potential security breaches.

Regarding seamless integration with quantum technologies, the growing ecosystem of quantum technologies, including quantum repeaters, quantum memory, and quantum computing, necessitates a communication protocol that can integrate seamlessly with these advancements. The systems and methods disclosed herein can be compatible with these technologies to facilitate a unified and efficient Quantum Internet infrastructure. Further, the systems and methods disclosed herein can support quantum teleportation and repeaters, essential for long-distance quantum communication, addressing a gap in current protocols.

Regarding higher throughput, the increasing demand for high-speed data transmission in quantum networks underscores the need for a protocol to deliver higher throughput. The systems and methods disclosed herein can use dynamic modulation techniques and efficient key generation processes enable higher data transmission rates than existing QKD protocols.

Regarding dynamic adaptation, communication and data networks are dynamic and depend on protocols adapting to changing network conditions and hardware capabilities. The systems and methods disclosed herein can use dynamic modulation and real-time adaptation capabilities to ensure optimal performance and reliability, even in fluctuating environments.

Regarding reduced complexity and cost, to facilitate widespread adoption, a quantum communication protocol that reduces the complexity and cost associated with implementation is needed. The systems and methods disclosed herein can achieve reduced complexity and cost by simplifying the hardware and software requirements and minimizing operational complexity, making it accessible for broader applications.

Regarding the future-proof design, as quantum technologies continue to evolve, a communication protocol that can remain relevant and effective in the face of future developments is needed. The systems and methods disclosed herein uses an innovative design and forward-thinking architecture thereby providing a future-proof solution ready to meet the demands of the evolving Quantum Internet landscape.

Regarding the hybrid approach for dual use, the systems and methods disclosed herein can enable a hybrid approach where traditional digital and quantum-encoded data can be transmitted over the same conventional channel. This dual-use capability allows using existing traditional communication infrastructure without requiring exclusive quantum infrastructure, significantly lowering the barrier to adoption and enabling a more seamless transition to quantum-enhanced networks.

Regarding quantum encoding, the Quantum Communication Protocol provided by the systems and methods disclosed herein can use advanced quantum encoding techniques to facilitate the secure and efficient transmission of various data types in the same quantum channel, including qubits, qudits, qumodes, and digital information. This flexibility in encoding enables the protocol to support a wide range of quantum and classical communication applications.

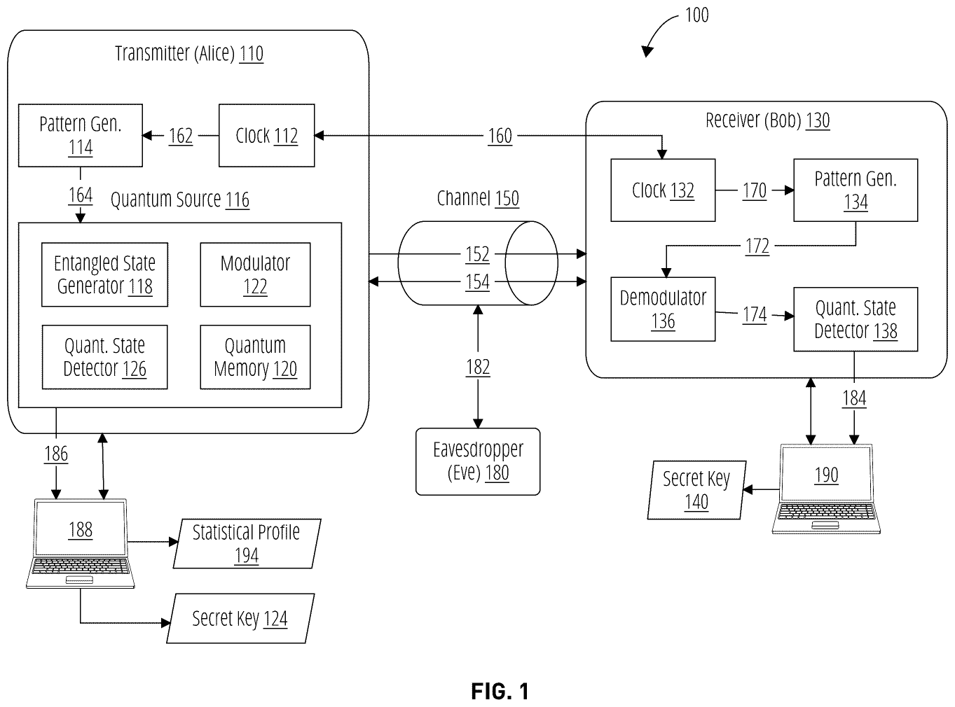

FIG. 1 illustrates quantum communications system 100, which is a non-limiting example of a quantum communication system. Quantum communications system 100 can be used for quantum key distribution but can also be used to directly encode quantum-state information 186 (e.g., quantum-state information 186 can be generated by applying an error correction code to secret key 124) onto quantum beam 152 to send quantum-state information 186 in a way that uses quantum mechanics to ensure security.

Quantum communications system 100 includes transmitter 110, receiver 130, and channel 150. Transmitter 110 generates quantum beam 152, which is transmitted to receiver 130 through channel 150. Receiver 130 selects a measurement basis, and the selected measurement basis is used to detect the quantum states of quantum beam 152. Quantum physics is relied on to ensure that the information conveyed by quantum beam 152 is secure against eavesdropping attack 182 from eavesdropper 180.

In quantum source 116, entangled state generator 118 can generate an entangled pair that includes a first half, which is referred to as a first state, and a second half, which is referred to as a second state. Generally, the entangled pair is discussed herein using a non-limiting example of entangled qumodes, such that the first state can. However, a person of ordinary skill in the art will understand that entangled qumodes is a non-limiting example and that various modifications and substitutions fall within the scope of the present disclosure. The first state is retained at transmitter 110 and the second state is transmitted via channel 150 to receiver 130 where it is detected. Quantum memory 120 stores the first state until sufficient time has passed for the second state have been measured at receiver 130, collapsing the wavefunction. When the entangled quantum state is a pair of entangled optical fields (e.g., qumodes), quantum memory 120 can be an optical delay line, such as a length of optical fiber.

Transmitter 110 and receiver 130 are synchronized such that the modulation pattern 164 and demodulation pattern 172 are correlated (e.g., the same but with a time offset corresponding to the propagation time through channel 150). Thus, transmitter 110 knows the measurement basis used by receiver 130 and uses this information when measuring via quantum state detector 126 quantum-state information 186 for the first state. Based on quantum-state information 186 for a series of first states (e.g., the first state from a series of entangled pairs) transmitter processor 188 generates statistical profile 194, which is different depending on whether receiver 130 received and measured the second states from a series of entangled pairs or the second states were intercepted and measured by eavesdropper 180. The statistical profile (e.g., statistical profile 194) resulting when receiver 130 measures the second state can represent a pure state, for example. According to certain non-limiting examples, when the second state is intercepted and measured by eavesdropper 180, transmitter 110 does not know what measurement basis was used by state eavesdropper 180 to measure the second states, resulting in statistical profile 194 deviating from that of a pure state (e.g., being indicative of a mixed state).

This scheme is closer to the Ekert91 (or E91) protocol for QKD than the BB84 protocol. Whereas BB84 uses a randomized measurement basis to send a random but deterministic pattern of polarization states, the E91 protocol uses entangled particles (e.g., photons with entangled polarization) and is inherently non-deterministic until the transmitter or receiver measures their half of the entangled pair, collapsing the wave function. Similarly, the system described in U.S. patent application Ser. No. 19/061,640, which is incorporated herein in its entirety by reference, can be deterministic like the BB84 protocol, in that the value of the quantum state and the measurement basis can be determined at the transmitter. The eavesdropper is limited by not knowing what random measurement basis was selected, and the transmitter and receiver are alerted to the presence of the eavesdropper due to the statistical properties/correlations between their measured values. The systems and methods disclosed herein are like E91 in that entangled particles are used the measurements are therefore random and not deterministic.

According to certain non-limiting examples, transmitter 110 includes synchronized timing device 112, pattern generator 114, quantum source 116, and modulator 122. Quantum source 116 produces a series of quantum elements 166 (e.g., photons) having respective quantum states. Modulator 122 modifies the quantum states of quantum elements 166 to generate quantum beam 152, which propagates from transmitter 110 through channel 150 to receiver 130.

Synchronized timing device 112 can be a clock (e.g., an atomic clock) that is synchronized with synchronized timing device 132 of receiver 130. Synchronized timing device 112 generates seed 162, which is sent to pattern generator 114. Based on the value of seed 162, pattern generator 114 determines modulation pattern 164 (e.g., a pattern of symbols, such as a binary string) that is applied to modulator 122 to determine a modulation pattern. Further, modulator 122 can receive a second input, quantum-state information 186, which is also used to determine how the quantum states of quantum elements 166 are modified.

According to certain non-limiting examples, transmitter processor 188 can be used for processing other information such as analyzing fluctuations in one or more fields propagating through the channels to detect anomalies, as discussed below. Additionally, transmitter processor 188 can determine whether channel 150 is compromised based on the analysis of the fluctuations and the detection of anomalies. Transmitter processor 188 can process data related to channel 150 to monitor properties of channel 150 to determine real-time conditions of the channel, and, based on the determined real-time conditions of the channel, determine how to dynamically adapt quantum beam 152 to optimize transmission through channel 150.

Consider a non-limiting example of a pair of polarization entangled photons in the anti-symmetric (or singlet) Bell quantum state

$$\vert {Ψ}^{-} 〉 = \frac{1}{\sqrt{2}} ( \vert HV 〉 - \vert VH 〉 ) , wherein \vert HV 〉 = \vert H 〉 ⊗ \vert V 〉 .$$

When the transmitter measures the horizontal polarization state |H [symbol] the receiver will measure the vertical polarization state |V [symbol] and vice versa. This entangled state can be expressed in the diagonal anti-diagonal measurement basis (or the 45°-135° measurement basis). The diagonal polarization state (i.e., 45°) can be expressed as

$$\vert D 〉 = \frac{1}{\sqrt{2}} ( \vert H 〉 + \vert V 〉 ) .$$

The anti-diagonal polarization state (i.e., 135°) can be expressed as

$$\vert A 〉 = \frac{1}{\sqrt{2}} ( \vert H 〉 - \vert V 〉 ) .$$

And the vertical and horizontal polarization states can be represented as

$$\vert H 〉 = \frac{1}{\sqrt{2}} ( \vert D 〉 + \vert A 〉 ) and \vert V 〉 = \frac{1}{\sqrt{2}} ( \vert D 〉 - \vert A 〉 ) .$$

Through substitution it can be found that

$$\vert {Ψ}^{-} 〉 = \frac{1}{\sqrt{2}} ( \vert AD 〉 - \vert DA 〉 ) .$$

Thus, when the transmitter measures the diagonal polarization state |D [symbol] the receiver will measure the anti-diagonal polarization state |A [symbol] and vice versa.

In this example, quantum source 116 can generate a series of photon pairs in the anti-symmetric Bell quantum state, wherein each photon pair occupies a respective time bin. Modulator 122 can be a series of phase plates (e.g., a quarter-wave plate (QWP) and a half-wave plate (HWP)). Between photon pairs, the wave plates are rotated to predefined angles thereby causing a rotation of the measurement basis for either the retained photon or the transmitted photon. For example, when modulator 122 changes the polarization of the transmitted photon, demodulator 136 can reverse the polarization change, ensuring that the same measurement basis is used for both halves of the entangled state.

As an alternative to using waveplates to modulate the polarization, one or more electro-optic modulators can be used to change the polarization state of the respective photons (e.g., by inducing phase shifts between polarization modes). Electro-optic modulators have the relative benefit of rapid switching times (e.g., <20 Gbps switching rate, which is limited primarily by the resistance/capacitance (RC) time constant of the electro-optic modulator), whereas mechanically rotating physical wave plates can be slower.

The illustrative example of modulator 122 being used to modulate the polarization is non-limiting. For example, when quantum source 116 generates photons (e.g., in number states or in coherent states), modulator 122 can be used to modulate the polarization, amplitude, phase, time, frequency (energy), quadrature, position (quadrature), momentum (quadrature), squeezing, wave-number vector ( [symbol] ), and a photon location (x). The quantized variable of quantum elements 166 (e.g., photons) that are modulated can be conjugate variables for which the Heisenberg uncertainty principle applies. A person of ordinary skill in the art will recognize that the types of modulation that can be performed by modulator 122 are not limited to the illustrative examples provided herein, and other types of modulation may be performed by modulator 122. Further, modulator 122 can include more than one modulating and optical components, including, for example, an electro-optic modulator, an acoustic-optic modulator, a balanced or an unbalanced Mach-Zehnder interferometer, one or more delay legs, a frequency modulator, a phase modulator, an amplitude modulator, one or more lenses, one or more prisms, and/or one or more diffraction gratings.

Further, quantum elements 166 can be modulated for other purposes in addition to preparing the quantum state. For example, when channel 150 allows wavelength division multiplexing (WDM) (e.g., there is a choice for which carrier frequency is used to transmit quantum beam 152), it can be advantageous to select for quantum beam 152 a frequency channel that is less noisy and/or has higher transmission than other frequency channels in the WDM. Selecting a less noisy/higher transmission frequency channel for quantum beam 152 can be realized by using modulator 122 to apply frequency modulation to shift the carrier frequency of the coherent states of quantum elements 166 to the central frequency of the less noisy frequency channel.

The above example of frequency shifting the carrier frequency of coherent states to correspond to a low-noise, high-transmission frequency channel, is a non-limiting example of how modulator 122 can be used to adapt quantum beam 152 based on the properties (e.g. transmission and noise properties) of channel 150. As discussed below, according to some examples, the channel properties can be periodically or continuously measured to determine real-time conditions of the channel, and the modulation performed by modulator 122 can be adjusted to dynamically adapt quantum beam 152 to optimize transmission through channel 150 based on the real-time conditions of channel 150. Another example of optimizing system performance by dynamically adapting quantum beam 152 based on real-time conditions can be to characterize which measurement subspaces have less noise and/or attenuation than other measurement subspaces and selecting a modulation scheme that uses the measurements subspaces having the more optimal characteristics (e.g., less noise and/or channel attenuation.

Channel 150 can be a communication channel, such an optical fiber or free space optical channel through which quantum beam 152 travels from transmitter 110 to receiver 130. As discussed above, channel 150 can be a plurality of channels, as in WDM, orthogonal frequency division multiplexing (OFDM), time division multiple access (TDMA), wavelength division multiple access (WDMA), etc., and some of these channels can be used to transmit quantum beam 152 while others are used to transmit classical communications 154. For example, classical communications 154 can be used for coordination and management functions between transmitter 110 and receiver 130. Further, classical communications 154 can be used for channel characterization or other purposes.

According to certain non-limiting examples, quantum communications system 100 can provide one-way channel authentication. The system comprises a transmitter 110, a quantum channel 150, and a receiver 130. The one-way channel authentication provides a way to ensure against a potential eavesdropper 180 tapping the channel. The transmitter 110 includes an entangled state generator 118 (within a quantum source 116) that produces entangled quantum states (e.g. entangled qumodes, or continuous-variable quantum modes). Each entangled pair consists of a first state (retained at the transmitter) and a second state (sent to the receiver). The first state is stored in a quantum memory 120 at the transmitter, while the second state is transmitted as part of a quantum beam 152 through channel 150 to the receiver. This unidirectional transfer (Alice→Bob) forms the basis of the one-way authentication scheme—the transmitter never needs to receive quantum states back from the receiver.

To encode information and authentication data onto the quantum beam, the transmitter 110 employs dynamic modulation synchronized between the two ends. A synchronized timing device 112 (e.g. an atomic clock) provides a timing seed 162 to a pattern generator 114, which in turn produces a modulation pattern 164. This modulation pattern is a secret, deterministic sequence (e.g. a binary string or a sequence of basis choices) that is used to drive a modulator 122. The modulator 122 applies the pattern to the outgoing entangled second states (quantum elements 166 such as photons or optical fields)—for example, by modulating their phase, polarization, or other properties—thereby imprinting quantum-state information 186 onto the transmitted beam.

Receiver 130 is equipped with its own synchronized timing device 132 that is synchronized with the transmitter's clock, and a corresponding pattern generator 134 that uses the receiver's clock (seed 170) to generate a matching demodulation pattern 172. Because both sides share synchronized time references, the receiver can apply the same pattern (with an appropriate time delay) to decode the incoming quantum states. A demodulator 136 at the receiver uses pattern 172 to undo the transmitter's modulation on the received second states (now arriving as quantum elements 174), preparing them for measurement. Immediately after demodulation, the receiver's quantum-state detectors 138 measure the incoming quanta to extract their encoded quantum-state information (e.g. measuring quadrature amplitudes if the qumodes carry amplitude/phase modulation). From these measurements, the receiver's system can derive a secret key 140.

The one-way channel authentication involves no return transmission of quantum states or bases information from Bob to Alice—all coordination is via the preset synchronized pattern. Transmitter 110 performs the authentication step by measuring its retained first states after a suitable delay. Since the transmitter knows exactly which basis or modulation was applied to each transmitted qubit/qumode (via pattern 164 and the shared clock), it also knows which basis the receiver should be measuring in. After allowing time for the receiver to detect the second state, the transmitter uses a quantum-state detector 126 to measure the first state stored in quantum memory 120 for each entangled pair. The outcomes of these measurements (over many entangled pairs) are processed by a transmitter processor 188 to build a statistical profile 194 of the correlations between the entangled halves. If the channel is secure (no eavesdropper), these statistics will reflect the expected pure-state entanglement correlations between the transmitter's and receiver's outcomes.

For example, the two halves might exhibit strong quantum correlations yielding a pure-state pattern of results (in an E91-like entangled protocol, their results are perfectly anti-correlated in a given basis). However, if an eavesdropping attack 182 occurred—meaning an interceptor (Eve 180) measured the second state in transit—the transmitter's first-state measurements will deviate from the expected pattern. Because Eve's measurement collapses the entangled state in an unknown basis, the transmitter's retained qumode will present as a statistical mixture (mixed state) rather than the pure state it would be if measured only after the authorized receiver's measurement. This manifests as anomalous statistics (e.g. increased entropy or error rates) in the transmitter's measurement outcomes, alerting the transmitter to the presence of an eavesdropper. In essence, the transmitter can unilaterally authenticate the channel by checking the integrity of these one-way entanglement correlations—any irreversible interaction with the quantum beam (as caused by eavesdropping or excessive loss) is detected by the transmitter's analysis of its own qumodes. All of this is achieved without a return message from Bob; the security check is one-way and relies purely on quantum effects and synchronized local operations.

According to certain non-limiting examples, the quantum states used for quantum elements 166 and quantum elements 174 and used in quantum beam 152 are qumodes. Qumode are quantum modes in which the quantum unit/element have quantum states with degrees of freedom that are continuous. For example, the qumodes can optical fields (e.g., coherent states, such as a laser beam) and the quantum states can have degrees of freedom represented by the quadratures of optical fields (e.g., position and momentum). In this case, the quadratures can be changed by modulating the amplitude and phase of the optical field, which are continuous variables.

For example, beam can use qumodes in transformed and modulated states, including but not limited to vacuum states and near vacuum states. Qumodes can be used for channel authentication, and robust quantum key distribution (QKD). Quantum communications system 100 (e.g., modulator 122 and demodulator 136) can use advanced dynamic modulation techniques, dynamic polarization, and Mode and Quantum Mode Decomposition Methods, including, but not exclusively, quantum transforms, such as the Quantum Fourier Transform (QFT), to enhance the reliability and efficiency of quantum communication.

According to certain non-limiting examples, quantum communications system 100 can use Gaussian-Modulated Coherent States (GMCS) and Continuous-Variable Squeezed States (CVSS).

According to certain non-limiting examples, quantum communications system 100 can use vacuum qumodes, near-vacuum qumodes, transformed vacuum qumodes, and modulated vacuum qumodes. The use of qumodes and variation thereof can provide improvements over GMCS and CVSS as the quantum states. For example, as discussed below, quantum communications systems 100 uses qumodes in novel and imitative ways that enhance security, reduce complexity, and improve adaptability.

According to certain non-limiting examples, transmitter 110 is responsible for generating entangled quantum states. As discussed above, transmitter 110 can include modulator 122, pattern generator 114, synchronized timing device 112, quantum source 116. Modulator 122 can be a first dynamic beam modulator that adjusts the properties of the quantum beams based on real-time conditions. Pattern generator 114 can be a first dynamic pattern generator that creates dynamic patterns for quantum state modulation using synchronized atomic clocks. Synchronized timing device 112 can be a first atomic clock that provides precise timing for synchronization with the receiver. Quantum source 116 can be a quantum light source that generates qumodes in vacuum states or near vacuum states. GMCS can be used in continuous-variable quantum key distribution, and they use coherent states of light that are modulated by a Gaussian distribution in one or both quadratures (amplitude and phase of the light field). CVSS can use squeezed coherent quantum states that reduce uncertainty in one quadrature (either the amplitude or the phase) of the electromagnetic field while increasing the uncertainty in the conjugate quadrature.

According to certain non-limiting examples, receiver 130 decodes and processes the quantum information. As discussed above, receiver 130 can include demodulator 136, pattern generators 134, synchronized timing device 132, and quantum state detector 138. Synchronized timing device 132 can be a second atomic clock that provides precise synchronization with transmitter 110. Pattern generator 134 can be a second dynamic pattern generator that uses synchronized patterns from the second atomic clock for decoding. Demodulator 136 can be a second dynamic beam modulator that matches the modulation patterns generated by the transmitter. Quantum state detector 138 can be a detection system that uses homodyne and heterodyne detection techniques to measure the quadratures of the received qumodes.

According to certain non-limiting examples, quantum communications system 100 can be initialized/setup and can be synchronized using the following steps. The setup process can begin with synchronizing synchronized timing device 112 and synchronized timing device 132 (e.g., the first and second atomic clocks). These clocks can be coordinated to provide precise timing and synchronization between transmitter 110 and receiver 130. Further, a fine timing measurement (FTM) can be used to determine the propagation time between transmitter 110 and receiver 130 through channel 150. According to certain non-limiting examples, the FTM protocol can be similar to that used for the WiFi standard (e.g., IEEE 802.11). The synchronized clocks generate a common seed (e.g., seed 162 and seed 170) used by the dynamic pattern generators at both the transmitter and receiver ends (e.g., pattern generator 114 and pattern generator 134). This ensures that both ends measure the quantum-state information using the same dynamic modulation patterns (e.g., modulation pattern 164 and demodulation pattern 172).

According to certain non-limiting examples, in the initial configuration, the transmitter and receiver are configured with the same initial parameters for quantum state preparation, modulation patterns, and detection settings. A secure channel is established and used for exchanging initial configuration data and verifying synchronization between the atomic clocks. For example, a previously established cryptographic key (e.g., a one-time pad) can be used to encrypt the information and send the encrypted information over classical communication channels to initialize the system. When quantum communications system 100 is initialized and operating securely using quantum communications, quantum communications system 100 can perform QKD to replenish/generate the amount of cryptographic key data (e.g., the number of bits of a one-time pad) that was consumed during the initialization of quantum communications system 100 can be replenished using QKD.

According to certain non-limiting examples, quantum data is transmitted for transmitter 110 to receiver 130 by modulating quantum elements 166 by modulating the optical fields passing through modulator 122. The dynamic pattern generator creates dynamic modulation patterns based on the synchronized atomic clock. These patterns are used to modulate the qumodes dynamically, enhancing security and data integrity.

According to certain non-limiting examples, channel 150 of quantum communications system 100 performs hybrid transmission in which both quantum states and traditional digital data are transmitted simultaneously over the same communication channel. This hybrid approach leverages existing infrastructure (e.g., telecommunications fiber optics) and reduces the need for exclusive quantum channels.

According to certain non-limiting examples, receiver 130 of quantum communications system 100 performs decoding and detection. For example, receiver 130 can use dynamic modulation patterns to decode the received qumodes that are the same as the dynamic modulation patterns used at transmitter 110 to modulate the qumodes. In this example, quantum state detector 138 can measure the quadratures using the same measurement basis as quantum state detectors 126. Further, any discrepancies or anomalies in the received data can be detected in real-time, ensuring prompt identification and mitigation of potential security breaches.

According to certain non-limiting examples, quantum communications system 100 can perform key generation and management. For example, seeds can be extracted directly from the qumodes, bypassing the need for classical communication during key sifting. This method simplifies the key generation process and enhances scalability. Further, the extracted seeds can be used to generate cryptographic keys and ensure secure communication.

According to certain non-limiting examples, quantum communications system 100 can perform dynamic adaptation. For example, the protocol can dynamically adapt to changing network conditions and hardware capabilities, ensuring consistent performance and reliability. This includes adjusting modulation patterns and detection parameters in real time based on current channel conditions.

According to certain non-limiting examples, channel 150 of quantum communications system 100 performs various security features, including one-way continuous quantum channel authentication and real-time anomaly detection. For one-way continuous quantum channel authentication, the systems and methods disclosed herein can secure communication over single or multiple quantum channels without reciprocal authentication processes. For example, quantum communications system 100 can leverage the intrinsic randomness of quantum states and synchronized patterns to authenticate data transmission. Further, quantum communications system 100 can provide real-time adjustments to modulation patterns based on atomic clock synchronization to further enhance security. For real-time anomaly detection, the systems and methods disclosed herein can us integrated mechanisms to continuously monitor the quantum channel for anomalies. These mechanisms rely on the statistical properties of the qumodes and their quadrature measurements to detect and mitigate potential security breaches.

According to certain non-limiting examples, quantum communications system 100 can be integrated with other quantum technologies to provide various synergies and additional functionalities. For example, quantum communications system 100 can be integrated with one or more quantum repeaters and memories. Consider that the systems and methods disclosed herein are fully compatible with quantum repeaters and quantum memories, ensuring seamless integration within a cohesive Quantum Internet infrastructure. This compatibility supports long-distance quantum communication and data storage. Further, quantum communications system 100 can be integrated with quantum computing. For example, the features of quantum communications system 100 facilitates integration with quantum computing systems, enabling advanced quantum applications and processing.

As discussed above, according to certain non-limiting examples, modulator 122 and demodulator 136 can use qumodes in vacuum states or near vacuum states for encoding quantum information. This choice of quantum state supports continuous variable (CV) quantum communication, which is well-suited for high-capacity data transmission. Modulator 122 and demodulator 136 can be dynamic beam modulators that dynamically adjusts the properties of quantum beams 152 based on real-time conditions, ensuring optimal data integrity and transmission efficiency.

According to certain non-limiting examples, synchronized Timing device 112 and synchronized timing device 132 can be atomic clocks. Synchronized Timing device 112 and synchronized timing device 132 can be two precisely coordinated time synchronization devices, such as atomic clocks. Each transmitter and receiver possesses one of these synchronized atomic clocks. The synchronized atomic clocks are used by the pattern generator to produce a common seed for modulating the quantum states, ensuring precise and synchronized operations between the transmitter and receiver.

According to certain non-limiting examples, quantum communications system 100 can use hybrid data transmission. For example, channel 150 can enable the simultaneous transmission of traditional digital and quantum states over the same communication channel. This hybrid approach leverages existing infrastructure, reducing the need for exclusive quantum channels and facilitating a smoother transition to quantum-enhanced networks.

According to certain non-limiting examples, quantum communications system 100 can provide cryptographic key generation and management. For example, in contrast to other QKD protocols that rely on classical communication for key sifting, the systems and methods disclosed herein can extract seeds directly from the qumodes. For example, secret key 124 and secret key 140 can be the cryptographic key that is sent from transmitter 110 to receiver 130 without sifting. This method simplifies the key generation process and eliminates the dependency on classical post-processing. According to certain non-limiting examples, quantum communications system 100 can provide dynamic adaptation. For example, the systems and methods disclosed herein can adapt dynamically to changing network conditions and hardware capabilities, ensuring consistent performance and reliability.

According to certain non-limiting examples, quantum communications system 100 can enable mode and quantum mode decomposition processes and dynamic modulation. For example, the systems and methods disclosed herein can employ mode and quantum mode decomposition processes, including the Quantum Fourier Transform (QFT).

According to certain non-limiting examples, quantum communications system 100 can enable respective security features, including, one-way continuous quantum channel authentication and real-time anomaly detection. Regarding one-way continuous quantum channel authentication, the systems and methods disclosed herein can use an authentication method that secures communication over single or multiple quantum channels without the need for reciprocal authentication processes. This method can adapt to evolving channel characteristics in real time to provide enhanced security and efficiency. Regarding real-time anomaly detection, integrated anomaly detection mechanisms can be used to continuously monitor the quantum channel (e.g., the channel in channel 150 that is used for quantum beam 152) for potential security breaches, enabling prompt identification and mitigation of threats.

### Continuous Variable Quantum States

According to certain non-limiting examples, quantum communications system 100 can use continuous variable quantum states. Unlike discrete variable quantum systems with finite-dimensional Hilbert spaces like qubits, continuous variable (CV) quantum states utilize infinite-dimensional spaces. This enables leveraging optical-communication technologies (e.g., technologies for modulating classical optical fields for telecommunications).

For example, the fundamental CV carriers can be quantum harmonic oscillators or qumodes. The qumodes can be represented using quantized vibrational states that are described in quantum field theory using annihilation and creation operators acting on Fock states (i.e., number states). The position and momentum operators follow Heisenberg uncertainty relations.

In optical implementations, the qumode quadrature amplitudes \hat{X} and \hat{P} correspond to the electromagnetic field amplitudes. Homodyne detection measures \hat{X} or \hat{P} through interference with a local oscillator.

According to certain non-limiting examples, the systems and methods disclosed herein can use photon number states, coherent states, squeezed states, and/or entangled Einstein-Podolsky-Rosen (EPR) pairs for transmitting and modulating continuous variable quantum information. Advanced CV techniques can be used to provide the foundations for scalable high-speed quantum communication.

### Wavelength Division Multiplexing

According to certain non-limiting examples, quantum communications system 100 can use wavelength division multiplexing (WDM) in channel 150 to provide data transmission including both quantum channels and classical channels in the same infrastructure. WDM allows multiple signals to be transmitted simultaneously over an optical fiber by modulating each signal on a different wavelength channel.

The systems and methods disclosed herein can leverage WDM to independently modulate information on multiple spectral modes or “qumodes” of the electromagnetic field. In CV communication, each qumode is in the infinite-dimensional Hilbert space of a quantum harmonic oscillator rather than discrete qubits or qudits.

Optical multiplexers combine the wavelength qumodes into a composite quantum signal. At the receiver, demultiplexers separate the qumodes into independent quantum channels. This parallel transmission boosts capacity and security through spatial resource multiplexing without discretization.

Advanced photon-efficient WDM techniques modulate properties like phase, polarization, and orbital angular momentum across the qumodes. By harnessing multi-wavelength quantum carriers, the systems and methods disclosed herein can achieve scalable high-dimensional CV quantum communication.

### Quantum Entanglement

According to certain non-limiting examples, the systems and methods disclosed herein can use quantum entanglement to realize various advantages. Quantum entanglement is a phenomenon where quantum states of two or more objects are described with reference to each other, even when separated by large distances. This non-local correlation is a fundamentally quantum effect with no classical analog.

Continuous variable entanglement deals with infinite-dimensional Hilbert spaces. Common examples are Einstein-Podolsky-Rosen (EPR) pairs of position/momentum or amplitude/phase entangled optical qumodes. These exhibit “spooky action at a distance” where measuring one qumode instantaneously collapses the state of the entangled partner.

The systems and methods disclosed herein can leverage CV entanglement to enable intrinsically secure quantum communication. Entangled qumodes act as a shared resource between the transmitter and receiver. Attempted eavesdropping introduces anomalies that can be detected using one or more entanglement verification measurements (similar to the Bell inequalities). This reveals the presence of an attack on the quantum channel without destroying the entanglement itself. Teleporting unknown quantum states is also enabled by using entanglement as a quantum channel.

Methods for distributing, verifying, and storing entanglement are active research areas. The systems and methods disclosed herein can use quantum repeaters and entanglement swapping to overcome limits on direct transmission distances. Exploiting quantum entanglement enables the systems and methods disclosed herein to achieve provably secure communication.

### Quantum Noise Analysis

According to certain non-limiting examples, the systems and methods disclosed herein can use quantum noise analysis. Quantum communication channels exhibit intrinsic noise due to the probabilistic nature of quantum states. Photon loss, damping, amplification, and other processes introduce uncertainties.

The systems and methods disclosed herein can use quantum noise analysis to model channel performance. Theoretical noise models quantify decoherence, dissipation, and other noise effects. Engineering quantum channels uses capacity theorems based on signal-to-noise ratios.

Continuous monitoring of quantum fluctuations enables the detection of anomalies arising from eavesdropping or interference. Noise levels exceeding modeled values indicate potential tampering. Randomized modulation provides further authentication by masking the quantum signal.

By combining analytical noise models with real-time fluctuation tracking, the systems and methods disclosed herein can identify deviations to maintain secure ultra-low noise performance. This resiliency against environmental and attack-based noise is a key advantage of the protocol.

### Quantum Fluctuations

According to certain non-limiting examples, the systems and methods disclosed herein can use quantum fluctuations. Quantum systems exhibit inherent uncertainties and fluctuations arising from conjugate variables as described by the Heisenberg uncertainty principle. Even in idealized isolated environments, quantum states feature fluctuations around expected values.

In continuous variable quantum communication, common fluctuations manifest as noise in qumode quadrature amplitudes and photon numbers. However, fluctuations can arise between any conjugate observables like energy/time, angular momentum/angle, etc. The variance in repeated measurements of any conjugate observables will reveal these intrinsic quantum fluctuations.

Tracking fluctuations in real time enables monitoring the quantum channel for anomalies. Sudden changes in variance levels can indicate environmental disturbance or adversarial tampering (e.g., eavesdropping attack 182).

By combining analytical noise models with active fluctuation tracking, the systems and methods disclosed herein can use data-driven authentication to verify the integrity of the quantum channel of channel 150 that is used to transmit quantum beam 152. Quantum fluctuations provide a signature for validating the transmission of true quantum states.

### Transmitter

According to certain non-limiting examples, transmitter 110 generates and modulates the continuous variable quantum states for communication using coherent laser sources and squeezers coupled to the quantum channel.

Wavelength division multiplexing enables preparing quantum states in parallel across distinct optical qumodes. Optical parametric oscillators produce squeezed states with quadrature entanglement. Electro-optic, acousto-optic, and electro-absorption modulators apply desired modulations.

According to certain non-limiting examples, synchronized timing device 112 and synchronized timing device 132 can be atomic clocks that provide synchronized randomness for modulating quantum states. Shared secret seeds (e.g., seed 162 and seed 170) enable intrinsically secure authentication. Based on the seeds, the measurement basis can be randomized for modulator 122 and demodulator 136. Modulator 122 can use various types of modulation such as phase, polarization, and orbital angular momentum modulation.

According to certain non-limiting examples, Quantum Pings (QPings) are created by sending transformed qumode vacuum or near vacuum states to monitor the quantum channel.

According to certain non-limiting examples, integrated photonics implementations can allow miniaturized, scalable transmitters. Chip-scale devices can generate and manipulate thousands of qumodes for high throughput. Transmitters 110 can use advanced nanophotonic components to provide compact, efficient transmitters.

### Quantum Channel

According to certain non-limiting examples, the quantum channel (e.g., channel 150) transmits the continuous variable quantum states (e.g., quantum beam 152) between the remote transmitting and receiving nodes (e.g., transmitter 110 and receiver 130). The systems and methods disclosed herein can use fiber optic and/or free-space links for channel 150.

Optical fibers provide low-loss guided transmission of quantum light. Ultra-low loss single-mode fibers can be used to maximize range. Quantum repeaters using entanglement swapping can be used to extend the transmission range.

Free-space channels use atmospheric or space links for line-of-sight transmission. Adaptive optics can be used to compensate for turbulence, for example. Satellite links can enable global-scale quantum communication.

The quantum channel can be engineered for high spectral efficiency matching the qumode structure. WDM multiplexer/demultiplexer (mux/demux) can align channels with allocated bandwidths. Environmental isolation can be used to maintain stable ultra-low noise performance.

### Receiver

Receiver 130 can measure and decode the continuous variable quantum states after transmission through the quantum channel (e.g., channel 150). This detection process performed by demodulator 136 and quantum state detector 138 can involve quantum measurements, demultiplexing, and digital signal processing.

For example, balanced homodyne detectors measure quadrature amplitudes of the qumodes. Demultiplexing can be used to separate the spatially multiplexed channels.

Analog-to-digital converters (ADCs) can be used to digitize the homodyne measurements at high sampling rates. Digital signal processing (DSP) algorithms can be used to process the measured signals and apply error correction procedures. Integrated photonic implementations can be used to provide chip-scale receivers.

The receiver leverages real-time quantum state tracking to monitor noise and fluctuations. Deviations can indicate eavesdropping or interference, triggering security protocols. Time synchronization can ensure that seed 162 matches seed 170, which can be used to authenticate valid quantum states.

### Shared Randomness Generation

Shared random secret keys can be used to provide intrinsically secure communication in the systems and methods disclosed herein.

The systems and methods disclosed herein use transmitter 110 and receiver 130 that each have access to synchronized atomic clocks (e.g., synchronized timing device 112 and synchronized timing device 132). These can be atomic clocks that allow the nodes to derive a shared random pattern (e.g., modulation pattern 164 and demodulation pattern 172) without needing to generate and distribute unique keys for each transmission.

The shared pattern can be continually refreshed following a security protocol to prevent potential physical attacks aimed at reverse engineering the pattern. The synchronized atomic clocks provide precision timing alignment to ensure proper modulation/demodulation using the updated random seeds in the systems and methods disclosed herein.

### Homodyne/Heterodyne Detection

The systems and methods disclosed herein can use quantum optical detectors to measure the continuous variable quantum states after transmission through the quantum channel. For example, homodyne and/or heterodyne detection schemes can be utilized.

Balanced homodyne detectors can be used to measure quadrature amplitudes of the quantum states with low noise. Local oscillator beams at the carrier frequency are mixed with the signals. This provides amplitude and phase information.

Heterodyne detection uses a local oscillator at a different frequency than the carrier frequency of quantum beam 152, resulting in amplitude/phase data for additional sidebands. Applying digital signal processing to the measured output can provide full-field characterization, enabling the reconstruction of quantum states from the classical data.

High-speed, high-efficiency photodiodes sensitive to single photons can detect the mixed optical signals. Integrated photonic implementations on photonic chips are promising for the development of chip-scale receivers.

### Real-Time Fluctuation Tracking

The systems and methods disclosed herein can use real-time tracking of quantum fluctuations to monitor and authenticate the quantum channel. Fluctuations in quadrature amplitudes and photon numbers can be analyzed for anomalies. Quantum fluctuations intrinsically arise from the probabilistic nature of quantum states. The variance of repeated measurements can be used to track these uncertainties. By combining analytical noise models with active tracking of fluctuations, the receiver can validate the integrity of the quantum states. Sudden changes in the variance can provide a warning of potential eavesdropping or interference.

Field programmable gate arrays (FPGAs) can be used for high-speed, real-time signal processing to extract fluctuations for analysis. Machine learning techniques can be used to optimize authentication protocols. Continuous authentication via fluctuations can provide an additional layer of security for the systems and methods disclosed herein. This leverages intrinsic quantum signatures, which are present even in complex network environments.

### Quantum Noise Monitoring

The systems and methods disclosed herein can use continuous monitoring of inherent quantum noise to detect potential eavesdropping or interference. Fluctuations in the quadrature amplitudes reveal the probabilistic nature of the quantum states. Quantum noise can arise from fundamental uncertainties described by Heisenberg's uncertainty principle. This intrinsic randomness can be harnessed to enhance security. Measurements from receiver 130 can be used track noise levels in the quadrature amplitudes in real-time across the quantum channel. Changes in the quantum noise variance outside of expected levels indicate deviations in the quantum states, triggering security protocols.

Machine learning techniques can be used to optimize noise authentication by modeling channel characteristics. Through the selection of the system design, ultra-low noise performance can be maintained for high sensitivity. Quantum noise monitoring can provide a built-in mechanism for the systems and methods disclosed herein to validate the integrity of the quantum states. This leverages the quantum uncertainties to protect against hacking attempts.

### Continuous Fluctuation Tracking

In addition to quantum-noise monitoring, the systems and methods disclosed herein can use real-time tracking of fluctuations in the continuous variable quantum states of quantum beam 152 from transmitter 110. Ongoing analysis of variance can be used to monitor deviations from expected quantum behavior. Fluctuations are an intrinsic signature of quantum states stemming from probabilistic uncertainties as required by the Heisenberg uncertainty principle.

According to certain non-limiting examples, transmitter 110 can monitor the fluctuations by tapping/diverting a portion of quantum beam 152 using a beamsplitter. According to certain non-limiting examples, the diverted portion of quantum beam 152 is entangled with the transmitted portion of quantum beam 152.

Although the two output beams exhibit quantum correlations in their fluctuations due to entanglement, the transmitter does not directly measure the entanglement itself. Instead, transmitter 110 sends the diverted part of quantum beam 152 to a homodyne detector, which measures its field quadratures. This reveals information about the quantum noise and fluctuations in that diverted part of quantum beam 152. Because the fluctuations are correlated between the entangled beams, monitoring the diverted beam provides data on fluctuations in the main part of quantum beam 152, which passes through channel 150 to receiver 130. The measurements by transmitter 110 on the diverted part of quantum beam 152 do not affect or disturb the transmitted part of quantum beam 152.

By continuously tracking the fluctuations via homodyne detection of the diverted beam, the transmitter can authenticate the quantum states without needing feedback from the receiver. This allows the detection of potential eavesdropping attacks while the data transmission remains undisturbed. Because fluctuations are inherent attributes of the quantum states, the transmitter can track them without needing feedback from the receiver. This provides enhanced security without requiring a classical communication channel. The transmitter can extract real-time statistics on the quadrature amplitude and phase fluctuations of the quantum channel. Machine learning and Quantum Machine Learning techniques can optimize authentication protocols to identify anomalies.

Sudden changes in the fluctuation levels outside of modeled channel behavior can trigger transmitter 110 to refresh the shared secret keys (e.g., modulation pattern 164). This defends against potential eavesdropping attempts. For example, pattern generator 114 can have a set of algorithms/patterns that can be used to generate modulation pattern 164 based on seed 162. Further, pattern generator 134 can have the same set of algorithms/patterns that can be used to generate demodulation pattern 172 164 based on seed 170. When it is determined that a currently used algorithm/pattern may be compromised, a signal can be sent to pattern generator 114 and pattern generator 134 to switch to the next algorithm/pattern in the shared set of algorithms/patterns.

Continuous tracking of quantum fluctuations by the transmitter gives the systems and methods disclosed herein an embedded method to validate the integrity of transmitted quantum states. This leverages quantum uncertainties to enhance security.

### Resilience Against Attacks

The systems and methods disclosed herein can provide resilience against various cyberattack vectors by leveraging the self-authentication capabilities of the quantum channel. For example, continuous monitoring of fluctuations enables detecting denial of service attacks and selectively discarding only compromised portions of the quantum data.

For example, the systems and methods disclosed herein can use a high-dimensional CV protocol, making complete denial of service attacks difficult compared to qubit-based QKD. Further, quantum communications system 100 can monitor the noise power spectrum and fluctuations to detect potential eavesdropping attempts.

Quantum communications system 100 can use post-processing to discard potentially compromised subsets of the data before key generation. According to certain non-limiting examples, attempted tampering introduces anomalies that are rapidly identified, allowing the affected portions of the quantum data to be discarded. The no-cloning theorem prevents perfect man-in-the-middle attacks without introducing detectable errors.

Quantum communications system 100 can use monitoring of the characteristic of channel 150 to avoid reliance on fragile classical channels (e.g., by dynamically adapting the modulation scheme based on real-time measurements of the channel conditions), thereby allowing the systems and methods disclosed herein to enhance resistance to denial of service, eavesdropping, tampering, and man-in-the-middle attacks. The quantum channel (e.g., channel 150) can provide intrinsic self-authentication capabilities.

The systems and methods disclosed herein can provide resistance to Denial of Service (DoS) attacks. Quantum communications system 100 can continuously authenticate the quantum channel by monitoring fluctuations, enabling quantum communications system 100 to detect when an attacker is overwhelming the link by injecting noise or excess photons. This allows selectively discarding only the compromised subsets of the quantum data stream instead of the entire batch. Fine-grained control over discarding small portions of the quantum data prevents DoS attacks from being able to overwhelm the system and shut down communication. Additionally, the high dimensionality of the CV protocol makes it harder to fully deny service compared to qubit-based systems. For example, a DoS at some frequencies can be avoided by switching to frequencies that are not being attached and filtering out the photons as the attached frequencies. Even when a partial DoS degrades channel 150, some capacity (e.g., channels, modulation schemes, etc.) can still remain for transmitting data.

According to certain non-limiting examples, the systems and methods disclosed herein can provide resistance to eavesdropping. By monitoring the noise power spectrum and quantum fluctuations for increases over the standard quantum limit, quantum communications system 100 can detect eavesdropping attacks in which eavesdropper 180 is trying to extract information from quantum beam 152. Post-processing of the quantum-state information 184 from quantum elements 174 can be performed using two-universal hashing to thereby discard portions of quantum-state information 184 that may have been compromised before key generation, preventing eavesdropper 180 from accessing any private information. Multidimensional modulation means eavesdropper 180 has to correctly reconstruct more parameters to successfully eavesdrop without being detected.

The systems and methods disclosed herein can provide resistance to tampering. Authentication of the continuous quantum channel ensures any tampering of the quantum states, such as interference or state manipulation, will be rapidly detected as an anomaly. Tampering will introduce excess noise and fluctuations outside the quantum limits, triggering the identification of the tampered portions, which can then be selectively discarded. Attempted tampering is, therefore, ineffective and does not compromise the integrity of the generated secret keys.

The systems and methods disclosed herein can provide resistance to Man-in-the-Middle attacks. The no-cloning theorem of quantum mechanics prevents an adversary (e.g., eavesdropper 180) from perfectly copying quantum states to insert themselves into the link without introducing detectable anomalies. Continuous authentication enables legitimate users to identify attempts to impersonate the transmitter or receiver.

Advantages provided by the systems and methods disclosed herein include, but are not limited to:
The quantum channel is self-authenticated based on the shared random dynamic pattern, without classical communication.
There is no need for computationally intensive privacy amplification, authentication codes, or other classical post-processing.
Immunity to man-in-the-middle attacks since no classical channel is required.
Enhanced resistance to DoS attacks by avoiding reliance on fragile classical channels.

### Quantum Channel Authentication

The systems and methods disclosed herein can perform quantum channel authentication using the techniques discussed below. For example, quantum communications system 100 can perform quantum channel authentication using only quantum transmission (e.g., quantum beam 152) without relying on classical communication channels (e.g., classical communications 154). For example, transmitter 110 and receiver 130 can continuously monitor quantum beam 152 to detect anomalies in the quantum states passing through channel 150.

The quantum signals exhibit intrinsic fluctuations and noise stemming from quantum uncertainties. Changes in these quantum signatures warn of potential eavesdropping or tampering.

No classical communication is required between the nodes for this authentication. Instead, a shared secret seed (e.g., modulation pattern 164 and demodulation pattern 172) derived from the synchronized timing devices (e.g., synchronized timing device 112 and synchronized timing device 132) allows each node to independently monitor channel integrity.

The dynamic quantum channel authentication provides real-time validation of the security. Classical post-processing for privacy amplification can be avoided, reducing complexity.

By leveraging quantum properties, the systems and methods disclosed herein can provide seamless authentication without the fragility of classical channels. Quantum uncertainties are transformed into assets for protection.

### No Reliance on Classical Channels

As discussed above, one advantage of the systems and methods disclosed herein is that supplementary classical communication channels are not necessary for authentication and security in existing quantum communication protocols, whereas many other QKD protocols require an additional public classical channel. The use of such a classical channel can introduce vulnerabilities, undermining quantum security. Adversaries can target the classical channel for denial-of-service attacks or tampering.

The systems and methods disclosed herein can intrinsically integrate quantum channel authentication based on monitoring inherent quantum signatures. No classical channel is necessary for transmitting authentication codes or other metadata. Avoiding fragile classical channels enhances robustness against active hacking attempts. Security resources can focus on protecting the quantum channel alone. Thus, the self-contained quantum channel maintains high speeds securely. Classical communication bottlenecks and security liabilities are eliminated through the quantum-only design.

### Modulation Based on Shared Random Patterns

The modulation scheme used by modulator 122 to modulate quantum element 166 and generate quantum beam 152 can use shared random patterns (e.g., modulation pattern 164 and demodulation pattern 172) to vary the quantum state parameters continuously, thereby providing a defense against eavesdropping attacks.

The shared random patterns can be generated by transmitter 110 and receiver 130 using their synchronized atomic clocks to seed a deterministic random number generator (e.g., a quantum random number generator), thereby producing a dynamic random sequence. This dynamic random sequence is a shared secret pattern that is used to control the modulation. For example, the shared secret pattern can be used to control the modulation by changing the amplitude and phase of the quantum states based on the shared secret pattern.

To eavesdropper 180 the resulting quantum beam 152 appears unpredictable, but to receiver 130 modulation pattern is deterministic. Any attempt by eavesdropper 180 to intercept the transmission will inevitably introduce anomalies in quantum beam 152 that can be detected at receiver 130.

Thus, the shared random modulation can be used to monitor the integrity of channel 150 and quantum beam 152, allowing the systems and methods disclosed herein detect eavesdropping attacks without depending classical communications 154 between the transmitter and the receiver.

Generally, the terms used herein have the following meanings. A channel is the medium through which quantum states travel. A channel can be free space (open air), fiber optic, or any medium capable of carrying quantum states. This highlights that the one-way authentication scheme is medium-agnostic—it can be implemented over existing fiber networks or new quantum-specific links. A detector or sensor is a device that measures quantum states. In context, this typically means photodetectors or homodyne detectors at the receiver (and possibly at the transmitter for the retained state) that perform the measurements of the quantum signal's properties (e.g., photon polarization, quadrature amplitude, etc.). A transmitter is a device that prepares and emits the quantum states (e.g., entangled near-vacuum qumodes). A receiver: The device/node that captures the quantum states after they traverse the channel and converts (e.g., decodes and measures) them to quantum-state information. A modulator is a component that applies mode adjustments or quantum state transformations. In hardware terms, this could be an electro-optic modulator, phase shifter, amplitude modulator, or even a set of waveplates for polarization—anything that changes a property of the quantum signal in a controlled way.

According to certain non-limiting examples, one-way quantum channel authentication can use of near-vacuum qumodes (NVQs) as quantum pings (QPings) scheme. An NVQ refers to a quantum mode (e.g., an electromagnetic field mode) that is in a vacuum or near-vacuum state—in other words, it contains very few or no photons. Despite carrying almost no energy, an NVQ still exhibits inherent quantum fluctuations (per the Heisenberg Uncertainty Principle) that can be exploited for communication and detection.

According to certain non-limiting examples, the QPing mechanism uses multiple NVQs are entangled together; for example, two entangled NVQs could be created such that their quantum states are correlated. Some of these entangled NVQ states (say one out of the pair) are sent through the channel, while the others are retained at the transmitter. The transmitted NVQ acts as the “ping”—it probes the channel's integrity—and the retained NVQ acts as the reference. Because of entanglement, if the quantum ping in the channel encounters any interaction, the retained partner will exhibit signs of that interaction. The QPing allows the transmitter to continuously monitor the channel without requiring any feedback from the receiver. In practice, the transmitter continuously generates these entangled NVQ pairs, sends out one of each pair as a sequence of pings, and measures the retained ones after the receiver (or an eavesdropper) would have had time to interact with the transmitted signals. Any anomaly in the retained NVQ's state (when compared to what it should be if the channel were ideal) indicates a potential security breach. This is a real-time, unidirectional monitoring: as long as QPing states are being sent, the transmitter is getting live feedback on channel security.

According to certain non-limiting examples, entangled state generator 118 can implemented using various approaches. For example, entangled state generator 118 can be implemented using spontaneous parametric down-conversion (SPDC), where a strong coherent pump laser field interacts with a nonlinear optical medium (e.g., a χ\hat{ }(2) nonlinear crystal) to generate correlated signal and idler photons. When configured below threshold in an optical parametric oscillator (OPO) or similar architecture, this process yields a two-mode squeezed vacuum state, a canonical example of a Gaussian entangled qumode pair. The signal and idler modes are entangled in quadrature observables, typically the position and momentum analogs of the electromagnetic field (e.g., X and P quadratures).

In an alternative implementation, entanglement generation can be achieved using linear optical elements in conjunction with squeezed states. For instance, two independent single-mode squeezed vacuum states may be generated and then combined at a balanced beam splitter with an appropriate relative phase (e.g., π/2) to produce an entangled two-mode squeezed state. These entangled outputs are also described as qumodes and can be represented by Gaussian Wigner functions centered at the origin of phase space but exhibiting elliptical contours due to quantum correlations.

While Gaussian continuous-variable (CV) entangled qumodes are preferred in certain embodiments due to their experimental accessibility and rich phase-space structure, this is non-limiting. A wide variety of entangled states may be used within the scope of the invention. In general, any pair of quantum states that are entangled via correlations in conjugate variables such as position and momentum, phase and number, or time and energy may be employed. Non-Gaussian entangled states, such as photon-subtracted squeezed states or entangled coherent states, may also be suitable, depending on the application and available measurement resources. A person skilled in the art will recognize that various entanglement generation techniques, both probabilistic and deterministic, can be employed without departing from the spirit and scope of the invention.

According to certain non-limiting examples, modulator 122 can implemented using various modulation modalities. For example, modulator 122 can be configured to modulate the transmitted half of the entangled quantum state. In this case, the entangled pair is first generated and then the second state (the transmitted half) is modulated while the first state is retained at the transmitter for later measurement. The modulation is applied in a multi-dimensional phase space, thereby forming a multi-dimensional modulation cluster. Dimensions of modulation may include quadrature amplitude and phase (e.g., via electro-optic phase and amplitude modulators), polarization (e.g., via wave plates or polarization beam splitters), frequency (e.g., via electro-optic modulation or chirped pump fields), and temporal degrees of freedom (e.g., using optical delay lines or pulsed-mode encoding).

By utilizing multiple modulation dimensions, the system creates a higher-entropy encoding space, which enhances security and enables discrimination between authentic and tampered signals. The size and structure of the modulation constellation within each modulation cluster can also be varied to adjust the difficulty of eavesdropping or state-cloning attacks. In some implementations, constellation points are distributed on a hypersphere in phase space; in others, non-uniform constellations are used to increase information entropy.

In addition to post-generation modulation of the transmitted half, modulation may be incorporated into the entanglement-generation stage. For example, in SPDC-based systems, modulating the pump laser's amplitude, phase, frequency, or polarization can affect the entangled output. Modulation of the pump field may result in correlated changes in the squeezing strength, squeezing angle, or spectral profile of the generated entangled states. This pre-entanglement modulation approach allows deterministic control over the structure of the resulting entangled qumodes and may simplify downstream decoding at the receiver. Still other implementations may utilize modulators embedded within waveguide-based or cavity-enhanced entanglement sources, allowing for dynamically programmable modulation profiles.

According to certain non-limiting examples, quantum state detector 126 can implemented using various modulation modalities. quantum state detector 126 is used to measure quantum-state information and the retained first state of respective entangled quantum pairs. For example, quantum state detector 126 can be configured to extract quantum-state information for the purpose of channel authentication. In particular, these measurements are used to detect whether the corresponding second state transmitted through the channel has undergone irreversible interactions, such as those resulting from environmental decoherence or an eavesdropper's measurement. If the channel is authentic, the entangled pair will remain in a pure state, and the quantum-state information extracted from the retained first state will match the expected statistical properties. In contrast, if the second state is intercepted, measured, or otherwise irreversibly perturbed, the retained state will degrade into a mixed state, and the statistical structure of the measurements will reflect this change.

Several measurement and quantum-state tomography techniques can be used to distinguish pure states from mixed states. One common approach is homodyne or heterodyne detection, which yields measurements of the quadrature amplitudes (X and P) of the retained qumode. These measurements may be used to reconstruct the covariance matrix of the state, from which purity and von Neumann entropy can be derived. Alternatively, Wigner function tomography may be performed, either via direct sampling or through inverse Radon transformation, to visualize whether the retained state occupies the surface (pure) or interior (mixed) of the Bloch sphere in phase space. Purity loss, broadened Gaussian width, or reduced negativity in the Wigner function are indicators of tampering or decoherence.

Other approaches may include photon number-resolving detection, parity measurements, or statistical filtering based on mode structure. Machine learning or Bayesian filtering may also be applied to infer the presence of channel compromise based on statistical deviations across repeated measurements. These techniques are provided as non-limiting examples; a person of ordinary skill in the art will appreciate that a wide variety of measurement and tomography protocols may be used to extract the necessary quantum-state information and authenticate the quantum channel.

According to certain non-limiting examples, the authentication process may rely on the efficient characterization of Gaussian continuous-variable states via quantum state tomography techniques tailored to Gaussian systems. For instance, the transmitter may estimate the first- and second-order statistical moments (means and covariances) of the retained qumode to reconstruct a covariance matrix that uniquely defines a Gaussian state. From this, the transmitter may compute a purity metric γ=1/\sqrt{detσ}, where σσ is the covariance matrix. A value of γ≈1 indicates a pure state, while a significant drop below unity signals a mixed state, which may reflect decoherence or tampering. In some implementations, entropy or trace-distance deviations may be computed to compare the retained state's reconstructed density matrix against an expected ideal. Additionally, emerging techniques such as classical shadow tomography for continuous-variable states may be used to estimate entropy, fidelity, or other observables from a limited number of measurements, further enabling robust, efficient authentication in real time. These techniques provide rigorous guarantees on the authentication accuracy even in adversarial settings and may be implemented using heterodyne-based certification protocols, which do not require assumptions about the channel or state preparation process. Thus, quantum-state tomography in its various forms offers a flexible and powerful framework for determining whether a retained qumode has remained in a high-purity entangled state or been degraded due to unauthorized interaction with the transmitted half.

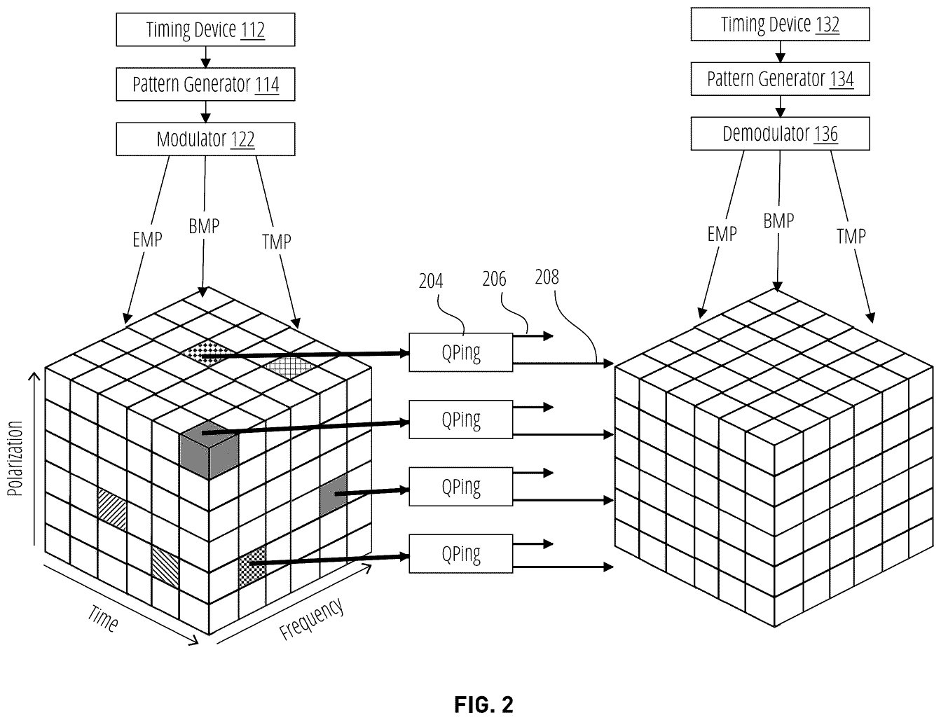

FIG. 2 shows an example of sending quantum pings (Qpings) through a quantum communication channel for one-way channel authentication. A Qping is a quantum entangled state in which part of the quantum entangled state is sent through the channel to a receiver and the remainder is retained and measured at the transmitter. As discussed above, a non-limiting example of a Qping is the entangled pair in which one half (e.g., the second state) is sent through the channel and the other half (e.g., the first state) is retained and measured at the transmitter. A person of ordinary skill in the art will understand that an entangled pair is a non-limiting example and that various modifications and substitutions (e.g., three or more entangled states) fall within the scope of the present disclosure.

According to certain non-limiting examples, QPing involves two or more near-vacuum qumode (NVQs) that are entangled, with some of them sent through the quantum channel while the others are retained by the transmitter. This process allows the transmitter to continuously monitor the integrity of the quantum channel without requiring feedback from the receiver. The entanglement ensures that any anomalies or unauthorized tampering are detectable in real-time by the transmitter.

According to certain non-limiting examples, NVQ represents qumodes that contain very few or no photons, also known as near-vacuum states. Despite the low photon count, these states still exhibit quantum properties related to quantum fluctuations and Heisenberg Uncertainty Principle (HUP), which are utilized in Quantum Field Theory.

According to certain non-limiting examples, the channel can be a guide wave field (GWF). To transfer NVQs through a quantum communication channel, the NVQs are coupled with a Guide Wave Field (GWF). The GWF acts as a carrier or guiding wave, facilitating the transmission of NVQs while maintaining their quantum properties.

FIG. 1 and FIG. 2 illustrate the setup of a one-way quantum channel authentication system, showing the transmission of NVQs through a channel, their coupling with GWF, and the use of QPings 204 for secure monitoring. For example, QPing 204 can include first state 206, which is retained at the transmitter, and second state 208, which is transmitted through channel 150 to receiver 130. FIG. 1 and FIG. 2 highlight the role of a time device, such as an atomic clock, which keeps track of timing and ensures synchronization between the transmitter and receiver. The Modulated Near-Vacuum Qumode (MNVQ) is the resulting quantum state after applying mode decomposition methods, like the quantum Fourier transform (QFT), to NVQ.

FIG. 2 shows the transmitter's side (with synchronized timing device 112, pattern generator 114, modulator 122) and the receiver's side (with synchronized timing device 132, pattern generator 134, demodulator 136) working in concert. The transmitter's and receiver's clocks are synchronized, allowing them to generate identical pseudorandom patterns for modulation (at Alice's side) and demodulation (at Bob's side) of the quantum signal. In this figure, an entangled pair is depicted explicitly: the first state 206 remains at the transmitter, and the second state 208 is sent through the channel as a Quantum Ping (e.g., QPing 204). QPing 204 refers to a technique where entangled near-vacuum qumodes (NVQs) are used as probe signals—one part of the entangled state (the “ping”) is transmitted to the receiver while the other part is held at the transmitter. The transmitter does this repeatedly (continuous pings) to monitor the channel's integrity in real time. Because the transmitted and retained halves are entangled, any interference or measurement on the traveling half (e.g., by an eavesdropper) will collapse the entangled state or decohere the state of the retained half. The transmitter can detect this by later measuring the first state 206 and noting discrepancies, as described in FIG. 1. Thus, FIG. 2 highlights how the system embeds an authentication mechanism within the one-way quantum transmission: the “quantum ping” is an entangled signal itself that doubles as a security check for the channel.

According to certain non-limiting examples, the QPing mechanism can be illustrated using the non-limiting example of entangled polarization states. In this example scenario, each photon (quantum element 166) traveling through the channel could have its polarization measurement basis dynamically modulated according to the pattern generator's output. The receiver's demodulator 136 would then apply the corresponding polarization basis to measure those photons.

This is a non-limiting example, and many other quantum degrees of freedom and modulation schemes can be employed. For instance, the quantum elements 166 may be continuous-variable states (qumodes of light) rather than single-photon polarizations. In such an embodiment, modulator 122 could perform phase and amplitude modulation on each qumode. FIG. 2 includes three degrees of freedom of modulation corresponding to (1) an emitter modulator pattern (EMP), which controls the emission patterns of the quantum states, (2) beam modulator pattern (BMP), which adjusts the beam properties, such as polarization and frequency, and a time modulator pattern (TMP), which modulates the timing aspects, synchronized by the time devices. These different modulator patterns can be used to change the state of the transmitted half of an entangled pair. For example, the time can be modulated using one or more delay lines to shift when a qumode is transmitted. Additionally or alternatively, the frequency of an optical field can be shifted, for example, using an acousto-optic modulator or by changing the frequency of a pump laser to an optical parametric oscillator (OPO) that generates the entangled state via spontaneous parametric down-conversion (SPDC). As discussed above, the polarization can be modulated using waveplates or an electro-optic modulator.

According to certain non-limiting examples, pattern generator 114 and pattern generator 134 are dynamic pattern generators (DPGs) that produce complex, multi-dimensional modulation patterns. The DPGs can be configured to handle multiple modulation dimensions simultaneously. For example, three kinds of modulation patterns are shown. Emitter modulator pattern (EMP) can control the emission characteristics of the quantum states at the transmitter. For example, EMP might dictate which basis or mode is used for each outgoing quantum state on each channel. The beam modulator pattern (BMP) can be used to adjust properties, such as polarization or frequency, of the quantum beam after the entangled state has been generated. The time modulator pattern (TMP) governs temporal modulation and timing synchronization. TMP might involve gating the emission of states in certain time bins or applying time-varying phase shifts, all aligned with the global clock.

Each of these patterns (EMP, BMP, TMP) represents a layer of modulation. Together, they form a multi-dimensional modulation cluster as previously described. Pattern generator 114 at the transmitter coordinates these layers when modulating the quantum states, and pattern generator 134 generates identical patterns (with appropriate delays) to coordinate decoding at the receiver. This means, for instance, at a given moment, pattern generator 114 and modulator 122 of transmitter 110 might rotate the polarization (according to BMP), tweak the phase (EMP), and send it in a specific time slot (TMP); the receiver's pattern generator 134 and demodulator 136 can be used to apply the corresponding inverse operations. The unit cells within the polarization-time-frequency grid can represent constellation points within the modulation cluster.

According to certain non-limiting examples, the large number of constellation points in the modulation cluster yields a robust one-way authentication capability. For example, an attempt by an attacker to tamper with the quantum communication on a channel will be immediately detected by the transmitter's monitoring of the entangled partners. For example, if an eavesdropper tries to intercept channel 3's photons, the transmitter's retained states for channel 3 will show anomalies, and likely the correlated structure across channels might be disrupted (since patterns could be interlinked). The figure implies that tampering cannot go unnoticed—the system is watching every channel in real-time through the entanglement correlations. Moreover, by having multiple channels, the system can be made resilient to attacks: even if an attacker tried a denial-of-service on one channel, the other channels could still carry on the communication, and the attack would be flagged without halting the entire session.

Notably, the transmitter and receiver stay in lockstep via their synchronized timing devices, ensuring that while the transmitter modulates (e.g., chooses a polarization angle or phase shift at a given time), the receiver is primed to demodulate in the corresponding basis when that quantum pulse arrives. Any entity lacking this synchronization—notably an eavesdropper—will effectively be measuring in the wrong basis randomly and thus introducing errors. FIG. 2 depicts how dynamic, synchronized modulation (across one or more degrees of freedom) is used to modulate quantum states for one-way transmission, and how the concept of a Quantum Ping is realized by sending entangled states (often in near-vacuum, minimally energetic form) to probe the channel's security continuously.

The use of polarization states as the entangled observable on quantum beam 152 is a non-limiting example, and a person of ordinary skill in the art will recognize that other quantum states and modulation schemes can be used. For example, quantum elements 166 can be qumodes, and modulator 122 can use phase and amplitude modulation.

### Entangled Qumode States

In various embodiments, the entangled states used for quantum channel authentication may be continuous-variable (CV) entangled states, such as entangled qumodes. Qumodes refer to quantized modes of the electromagnetic field, typically optical modes, where information is encoded in the quadrature components of the field (e.g., amplitude and phase). Entangled qumode states are frequently realized as Gaussian states, including two-mode squeezed vacuum states that exhibit strong quantum correlations between paired modes. These correlations can be exploited to detect disturbances in the channel, as any irreversible interaction with one qumode (e.g., a measurement or loss event) affects the statistical properties of its entangled partner. Entangled qumodes may also be modulated across multiple dimensions, including amplitude, phase, polarization, frequency, and time, enabling both high-dimensional encoding and enhanced detection of tampering.

In various embodiments, the entangled quantum states used for channel authentication are continuous-variable (CV) entangled states, particularly those comprising entangled quantum modes, or “qumodes,” of the electromagnetic field. Qumodes refer to optical modes in which quantum information is encoded in continuous degrees of freedom, such as the quadrature amplitudes of the field. These quadratures, commonly denoted \hat{X} and \hat{P}, corresponding to amplitude and phase (or position and momentum analogs), form a conjugate pair. Entangled qumodes exhibit non-classical correlations in these quadratures, meaning that measurement outcomes on one mode reveal information about the corresponding quadrature of its entangled partner. Depending on the entangled state type, these correlations may be perfect or statistical, and they can be used to detect any irreversible disturbance, such as measurement or decoherence, of the transmitted half of an entangled pair. Various classes of entangled qumodes exist, each with distinct physical properties and mathematical representations.

One widely used entangled qumode state is the Two-Mode Squeezed Vacuum (TMSV) state, which is the canonical entangled Gaussian state employed in CV quantum optics. It is typically generated by a non-degenerate spontaneous parametric down-conversion (SPDC) process in a nonlinear optical medium, such as a crystal within an optical parametric oscillator (OPO). The TMSV state is often expressed in the Fock basis as:

$${{\vert ψ 〉 = \sqrt{1 - {λ}^{2}} {\sum }_{n = 0}^{∞} {λ}^{n} \vert n 〉}_{A} \vert n 〉}_{B}$$

where λ is the squeezing parameter, and |n [symbol] _{A}|n [symbol] _{B} denotes a joint number state with nn photons in both modes A and B. This representation highlights the perfect photon-number correlations between the modes. Although not typically expressed as a superposition of coherent states, the TMSV state corresponds to a Gaussian Wigner function centered at the origin of phase space, with reduced variance along the joint quadratures \hat{X}_{A}-\hat{X}_{B} and \hat{P}_{A}+\hat{P}_{B}. These correlations reflect strong entanglement and enable one-way authentication, as any disturbance to one mode, such as unauthorized measurement, alters the quantum statistics of its partner. The TMSV state underpins many CV-QKD protocols and is compatible with homodyne or heterodyne detection schemes.

Another representative entangled qumode state is the position-momentum entangled state, also referred to as the continuous-variable analog of the Einstein-Podolsky-Rosen (EPR) state. It may be written in the idealized form:

$${{\vert EPR 〉 = \int dx \vert x 〉}_{A} \vert x 〉}_{B} \vert$$

where |x [symbol] _{A} and |x [symbol] _{B} are eigenstates of the position quadrature for modes A and B, respectively. In this formulation, the two modes are perfectly correlated in position and anti-correlated in momentum. Although such idealized EPR states are not physically realizable (due to the need for infinite squeezing), practical approximations using strongly squeezed TMSV states can emulate these correlations to a high degree. Position-momentum entangled states are especially relevant for protocols involving quantum sensing, quantum teleportation, and channel authentication, where precise joint correlations can reveal small deviations caused by environmental noise or eavesdropping. Measurement of one quadrature on mode B allows prediction of the same quadrature on mode A with precision exceeding classical limits, making such states valuable for one-way verification schemes.

A third class of entangled qumode states comprises entangled Schrödinger cat states, where each qumode exists in a superposition of coherent states. An example of such a state is:

$${{{{\vert Ψ 〉 = \frac{1}{\sqrt{2}} ( \vert α 〉}_{A} \vert α 〉}_{B} + \vert - α 〉}_{A} \vert - α 〉}_{B} )$$

where |α [symbol] and |−α [symbol] are coherent states of equal amplitude but opposite phase. This state represents a type of entangled “cat state,” in which each subsystem is in a coherent superposition of macroscopically distinguishable states. These states are inherently non-Gaussian and exhibit quantum interference in their Wigner functions, including regions of negativity. Such properties make them useful for error-corrected quantum information encoding, bosonic code schemes, and fault-tolerant quantum computing architectures. In the context of quantum authentication, entangled cat states are highly sensitive to decoherence and thus serve as fragile probes, any interaction with the transmitted half rapidly destroys the coherence, allowing the transmitter to detect tampering with high confidence. Although more difficult to generate and stabilize than Gaussian states, entangled cat states provide a valuable tool in advanced quantum communication systems, particularly when high fidelity and fault detection are priorities.

### Generating Entangled Qumode States

Entangled qumode states may be generated using a variety of mechanisms. In one embodiment, entanglement is produced via spontaneous parametric down-conversion (SPDC) in a nonlinear optical medium such as a crystal within an optical parametric oscillator (OPO). When pumped with a coherent laser source and operated below threshold, the OPO can generate pairs of entangled photons or field modes known as the signal and idler. These modes may exhibit strong squeezing and are suitable for implementing two-mode squeezed vacuum states. In another embodiment, entanglement may be created using linear optics techniques. For example, two independently prepared single-mode squeezed vacuum states can be interfered on a balanced beam splitter with appropriate relative phase. This combination can yield an entangled two-mode state that behaves similarly to those generated via SPDC. Additional methods for entanglement generation include waveguide-integrated photonic circuits, quantum dot systems, and superconducting qubit platforms, among others.

### Other Entangled States

While entangled qumodes represent a preferred implementation in many scenarios, they are merely one non-limiting class of entangled states. Other examples of entangled pairs include polarization-entangled photon pairs, which may be entangled in horizontal/vertical or diagonal/anti-diagonal polarization bases. Further alternatives include position-momentum entangled pairs, where spatial or momentum correlations can be measured; energy-time entangled pairs, which correlate detection times or frequency differences; and time-bin entangled states, which encode information in distinct temporal modes. These entangled states may be used in optical fiber links, free-space quantum communication, or hybrid quantum systems, depending on implementation constraints. The choice of entanglement modality may be guided by channel characteristics, compatibility with hardware, or desired protocol features.

In addition, the disclosed quantum authentication techniques are not limited to bipartite entanglement. Multipartite entangled states involving three or more particles may be used in certain embodiments. For example, Greenberger-Horne-Zeilinger (GHZ) states can be employed to enable multi-party authentication or shared trust among multiple nodes. Other multipartite entangled states such as W states, cluster states, and general graph states may be useful in contexts such as measurement-based quantum computing or distributed quantum networks. These states may offer benefits in redundancy, fault tolerance, or protocol flexibility, and their use is within the scope of the present disclosure. The specific type and dimensionality of the entangled state may be selected based on the requirements of the authentication protocol or the capabilities of the underlying hardware.

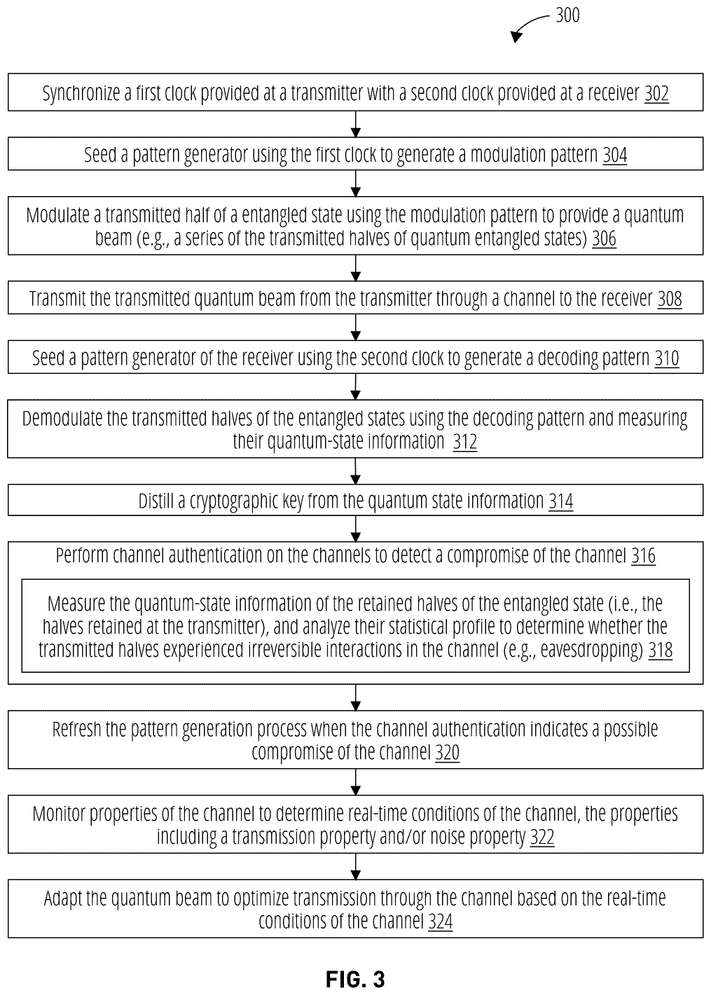

FIG. 3 illustrates an example method 300 for authenticating a quantum communications channel and providing secure communications. Although the example method 300 depicts a particular sequence of operations, the sequence may be altered without departing from the scope of the present disclosure. For example, some of the operations depicted may be performed in parallel or in a different sequence that does not materially affect the function of the method 300. In other examples, different components of an example device or system that implements the method 300 may perform functions at substantially the same time or in a specific sequence.

The flowchart in FIG. 3 illustrates an example method 300 for the one-way quantum channel authentication protocol, outlining a non-limiting example of sequence of operations carried out by quantum communications system 100, from initialization to key distillation and channel monitoring.

According to some examples, step 302 of the method includes synchronizing a first clock provided at a transmitter with a second clock provided at a receiver. For example, synchronized timing device 112 illustrated at transmitter 110 in FIG. 1 may be synchronized with synchronized timing device 132 at receiver 130.

According to certain non-limiting examples, the transmitter's clock is synchronized with the receiver's clock. In practice, both sides may use a highly stable time source (e.g. atomic clocks) that are aligned so that both parties share a common time reference. This synchronization underpins all subsequent pattern generation and ensures that transmitted and received signals can be correlated in time.

According to some examples, step 304 of the method includes seeding a pattern generator using the first clock to generate a modulation pattern at step 304. For example, synchronized timing device 112 illustrated in FIG. 1 may seed pattern generator 114 to generate modulation pattern 164.

According to certain non-limiting examples, the transmitter's synchronized clock is used to provide a seed value that is fed into the transmitter's pattern generator 114 to produce modulation pattern 164. This modulation pattern is essentially a pseudorandom (but deterministic) code—for example, a binary sequence or a schedule of basis rotations—that will be used to determine how the quantum signals are modulated. The seed might be derived from the clock's timing signal or a combination of shared secrets and timing.

According to some examples, step 306 of the method includes modulating a transmitted half of an entangled state using the modulation pattern to provide a quantum beam (e.g., a series of the transmitted halves of quantum entangled states). For example, modulator 122 of transmitter 110 illustrated in FIG. 1 may modulate a transmitted half of an entangled state using the modulation pattern 164 to provide quantum beam 152, which is a series of the transmitted halves of the quantum entangled states.

According to certain non-limiting examples, the transmitter modulates the transmitted half of each entangled pair according to modulation pattern 164. In other words, as entangled photons or qumodes are produced, the transmitter applies the pattern (e.g., modulating frequency, switching polarization angles, phase shifts, etc.) to randomize the transmission mode of the output quantum beam 152 which is a sequence of modulated quantum states. According to certain non-limiting examples, the first halves of these pairs remain un-modulated and stored locally. Among the uses of the retained halves of the entangled pairs is delayed measurement for channel authentication, as discussed below, and the retained halves of the entangled pairs can be used for secret key distillation for QKD.

According to some examples, step 308 of the method includes transmitting the transmitted quantum beam from the transmitter through a channel to the receiver. For example, quantum beam 152 in FIG. 1 may be transmitted from transmitter 110 through channel 150 to receiver 130.

According to certain non-limiting examples, the modulated quantum beam is sent one-way through the quantum channel 150 to the receiver. This could be through a fiber optic line, free-space optical link, or any medium capable of preserving quantum states. No quantum signal is sent in the reverse direction—this is a single-pass transmission from Alice to Bob.

According to some examples, step 310 of the method includes seeding a pattern generator of the receiver using the second clock to generate a decoding pattern. For example, synchronized timing device 132 illustrated in FIG. 1 may seed pattern generator 134 of receiver 130 to generate demodulation pattern 172.

According to certain non-limiting examples, in parallel with the above steps but tine delayed based on the propagation time from the transmitter to the receiver, the receiver uses its synchronized clock to seed its own pattern generator 134, creating a decoding pattern that matches the transmitter's modulation pattern. Because the clocks are synchronized, the receiver can generate an identical pseudorandom sequence locally. This decoding pattern dictates how the receiver will configure its demodulator over time (for instance, which basis to measure each incoming quantum state.

According to some examples, step 312 of the method includes demodulating the transmitted halves of the entangled states using the decoding pattern and measuring their quantum-state information. For example, the demodulator 136 illustrated in FIG. 1 may demodulate the transmitted halves of the entangled states using the decoding pattern and measuring their quantum-state information.

According to certain non-limiting examples, as the quantum beam arrives, the receiver demodulates the transmitted halves of the entangled states using the decoding pattern and immediately measures them. For example, if the transmitter modulated the transmitted halves of the quantum entangled state at time t, the receiver's demodulator 136 (with pattern 172) can reverse this modulation at the corresponding time and measure that quadrature via detector 138. This yields the quantum-state information 184 from the signal—essentially the raw data, such as a string of measured bits or continuous values.

According to some examples, step 314 of the method includes distilling a cryptographic key from the quantum state information. For example, the receiver 130 illustrated in FIG. 1 may distill secret key 140 from quantum-state information 184.

According to certain non-limiting examples, the receiver then processes the measured quantum-state information to distill a cryptographic key (or retrieve the transmitted message). In QKD usage, this could involve error correction and privacy amplification on the raw measurements to produce a secure secret key 140. In this one-way system, much of the usual two-way sifting is not needed since the transmitter and receiver were already in sync on basis choices; thus, key distillation can be more straightforward (often just error correction to correct any physical noise errors and channel loss).

According to some examples, step 316 of the method includes performing channel authentication on the channels to detect a compromise of the channel. For example, the transmitter processor 188 illustrated in FIG. 1 may perform channel authentication on statistical profile 194 to detect a compromise of channel 150.

According to certain non-limiting examples, the transmitter, after sending all or a subset of the quantum states, performs a channel authentication analysis. This is the step where the transmitter measures its retained first states (using quantum-state detector 126) and compares the statistics to expected ideals (as explained in FIG. 1). If the observed correlations match the pattern expected from an untampered channel, the channel is deemed authenticated (secure). If significant anomalies are detected (indicating possible eavesdropping or faults), the transmitter flags the channel as compromised.

According to some examples, step 318 of the method includes measuring the quantum-state information of the retained halves of the entangled state (i.e., the halves retained at the transmitter). Further, step 318 of the method can include analyzing quantum-state information 186 of the retained halves of the entangled state to generate statistical profile 194, which is then used to determine whether the transmitted halves experienced irreversible interactions in the channel (e.g., eavesdropping). For example, the quantum state detector 126 illustrated in FIG. 1 may measure quantum-state information 186, which is processed to derive statistical profile 194 (e.g., first and second statistical moments). Statistical profile 194 is then analyzed to determine whether the transmitted halves experienced irreversible interactions in channel 150 (e.g., eavesdropping by eavesdropper 180).

According to certain non-limiting examples, if the channel authentication (step 316) indicates a possible compromise, the system can refresh the pattern generation process. In practice, this means discarding the current modulation pattern/seed and using a new seed (perhaps derived from fresh entropy or the newly distilled key) to generate a new modulation pattern. This “reset” makes it even harder for an attacker to persist or to use information from the old pattern on future transmissions. Even if no compromise is detected, the system might periodically refresh the pattern as a precautionary measure.

According to some examples, step 320 of the method includes refreshing the pattern generation process when the channel authentication indicates a possible compromise of the channel. For example, the quantum communications system 100 illustrated in FIG. 1 may refresh the pattern generation process used by pattern generator 114 and pattern generator 134 when the channel authentication indicates a possible compromise of the channel.

According to certain non-limiting examples, throughout the operation (and especially if errors start to increase), the transmitter (or receiver) can monitor the physical properties of the channel in real time. This includes tracking the transmission loss, noise level, background photons, or any other pertinent transmission property and/or noise property of channel 150. Dedicated monitoring pulses or the quantum signal itself can be used to gauge these conditions.

According to some examples, step 322 of the method includes monitoring properties of the channel to determine real-time conditions of the channel, the properties including a transmission property and/or noise property. For example, the transmitter processor 188 illustrated in FIG. 1 may monitor properties of the channel to determine real-time conditions of the channel, the properties including a transmission property and/or noise property.

According to certain non-limiting examples, based on the monitored real-time conditions, the transmitter may adapt the quantum beam to optimize transmission. For example, if the channel is getting noisier, the transmitter could switch to a more noise-tolerant modulation format or reduce the sending rate. If losses increase, the transmitter might increase signal strength or move to a different wavelength, etc. This dynamic adaptation ensures that the quantum communication remains robust and efficient despite changing environmental conditions.

According to some examples, step 324 of the method includes adapting the quantum beam to optimize transmission through the channel based on the real-time conditions of the channel. For example, quantum source 116 illustrated in FIG. 1 may adapt quantum beam 152 to optimize transmission through channel 150 based on the real-time conditions of the channel. For example, if a particular constellation points in the modulation cluster it particularly noisy, the transmitter and receiver might adapt the modulation scheme to avoid that constellation point.

According to certain non-limiting examples, as a final validation, the transmitter measures the quantum-state information of the retained halves of the entangled states (the first states in memory) and analyzes their statistical profile. This is essentially performing quantum state tomography on the transmitter's qumodes to definitively check for any irreversible interactions that the transmitted qumodes experienced in the channel (e.g. an eavesdropper's measurement). A deviation of the retained state's statistics from what is expected (i.e. a loss of purity or increase in entropy) would confirm that the corresponding transmitted state was measured or disturbed in transit. This step solidifies the channel authentication by using the quantum entanglement correlations themselves as evidence of security or breach.

According to certain non-limiting examples, method 300 provides one-way quantum authentication procedure: clock sync→pattern generation→modulation→one-way transmission→decoding→key extraction, alongside continuous channel monitoring and post-measurement authentication checks. Notably, channel authentication occurs with without classical two-way handshake for basis reconciliation or challenge-response; the only classical coordination needed is the initial clock sync (which can be established via a secure side channel or prior arrangement). The result is a streamlined yet robust protocol for quantum-secured communication.

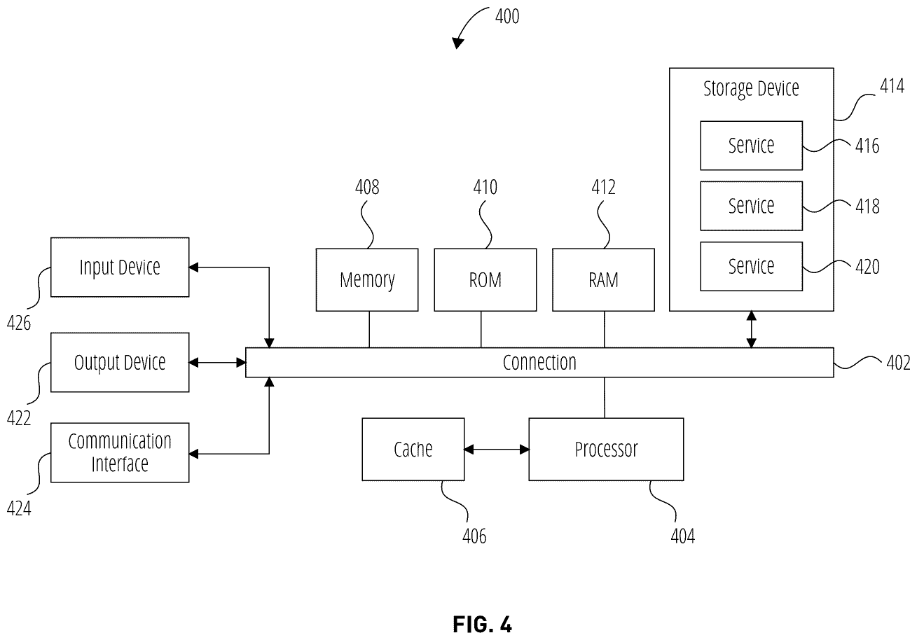

FIG. 4 shows an example of computing system 400. The computing system 400 can be a router, switch, network control appliance, network management appliance, or an analytics engine, for example. The computing system 400 can perform the functions of one or more of transmitter processor 188 or receiver processor 190. The computing system 400 can be part of a distributed computing network in which several computers perform respective steps in method 300 and/or the functions of transmitter processor 188 or receiver processor 190. The computing system 400 can be connected to the other parts of the distributed computing network via connection 402 or communication interface 424. Connection 402 can be a physical connection via a bus, or a direct connection into processor 404, such as in a chipset

architecture. Connection 402 can also be a virtual connection, networked connection, or logical connection.

In some embodiments, computing system 400 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 400 includes at least one processing unit or CPU (e.g., processor 404) and connection 402 that couples various system components including system memory 408, such as read-only memory (e.g., ROM 410) and random-access memory (e.g., RAM 412) to processor 404. Computing system 400 can include a cache of high-speed memory 406 connected directly with, in close proximity to, or integrated as part of processor 404. Processor 404 may essentially be a completely self-contained computing system, containing multiple cores or processors, a bus, memory controller, cache, etc. A multi-core processor may be symmetric or asymmetric.

Processor 404 can include any general-purpose processor and a hardware service or software service, such as service 416, service 418, and service 420 stored in storage device 414, configured to control processor 404 as well as a special-purpose processor where software instructions are incorporated into the actual processor design.

To enable user interaction, computing system 400 includes an input device 426, which can represent any number of input mechanisms, such as a microphone for speech, a touch-sensitive screen for gesture or graphical input, keyboard, mouse, motion input, speech, etc. Computing system 400 can also include output device 422, which can be one or more of a number of output mechanisms known to those of skill in the art. In some instances, multimodal systems can enable a user to provide multiple types of input/output to communicate with computing system 400. Computing system 400 can include a communication interface 424, which can generally govern and manage the user input and system output. There is no restriction on operating on any particular hardware arrangement, and therefore the basic features here may easily be substituted for improved hardware or firmware arrangements as they are developed.

Storage device 414 can be a non-volatile memory device and can be a hard disk or other types of computer-readable media that can store data that are accessible by a computer, such as magnetic cassettes, flash memory cards, solid state memory devices, digital versatile disks, cartridges, random access memories (RAMs), read-only memory (ROM), and/or some combination of these devices.

The storage device 414 can include software services, servers, services, etc., that when the code that defines such software is executed by the processor 404, it causes the system to perform a function. In some embodiments, a hardware service that performs a particular function can include the software component stored in a computer-readable medium in connection with the necessary hardware components, such as processor 404, connection 402, output device 422, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general-purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

### ADDITIONAL CONSIDERATIONS

The foregoing described embodiments have been presented for the purpose of illustration; they are not intended to be exhaustive or to limiting to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, described modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may include one or more general-purpose computing devices selectively activated or reconfigured by one or more stored computer programs. A computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Described embodiments may also relate to a product that is produced by a computing process described herein. Such a product may include information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

### Aspects

The present technology includes computer-readable storage mediums for storing instructions, and systems for executing any one of the methods embodied in the instructions addressed in the aspects of the present technology presented below:

Aspect 1. A method for authenticating a quantum communication channel, comprising: (a) preparing a plurality of quantum states, including vacuum states, near-vacuum states, and modulated quantum states; (b) encoding authentication data into the quantum states using dynamic beam modulation; (c) transmitting the quantum states over a plurality of quantum channels; (d) synchronizing a transmitter and a receiver using time devices to provide precise timing coordination; (e) transmitting a second state of each entangled pair through the quantum communication channel from the transmitter to the receiver while retaining a first state at the transmitter; (f) measuring quantum-state information of the retained first states; and (g) determining, based on the measured quantum-state information, whether one or more of the second states underwent an irreversible interaction during transmission.

Aspect 2. The method of aspect 1, wherein the quantum states are prepared using a quantum light source configured to generate vacuum states, near-vacuum states, and modulated quantum states.

Aspect 3. The method of aspect 1, wherein the dynamic beam modulation is performed using a dynamic beam modulator configured to adjust beam properties in real time.

Aspect 4. A quantum communication system, comprising: (a) a transmitter configured to: (i) prepare quantum states including vacuum, near-vacuum, and modulated states; (ii) encode authentication data into the quantum states using dynamic modulation; and (iii) transmit second states of entangled pairs through a quantum communication channel; (b) a receiver configured to receive the second states and decode authentication data; (c) time synchronization devices at the transmitter and receiver configured to maintain coordinated operation; and (d) a quantum-state authentication system configured to detect whether one or more second states underwent an irreversible interaction during transmission.

Aspect 5. The system of aspect 4, wherein the time synchronization devices comprise atomic clocks calibrated to minimize timing discrepancies between the transmitter and the receiver.

Aspect 6. The system of aspect 4, wherein the quantum-state authentication system comprises an anomaly detection subsystem configured to use machine learning algorithms to identify security anomalies.

Aspect 7. A method for generating and using decomposed near-vacuum qumodes for quantum authentication, comprising: (a) preparing near-vacuum qumodes; (b) transforming the near-vacuum qumodes into decomposed states using quantum operations; (c) encoding authentication data into the decomposed states; (d) transmitting second states of the decomposed qumodes through a quantum communication channel while retaining corresponding first states; and (e) analyzing quantum-state information from the first states to determine whether the second states underwent an irreversible interaction.

Aspect 8. The method of aspect 7, wherein the quantum operations include a quantum Fourier transform.

Aspect 9. The method of aspect 7, further comprising using the decomposed near-vacuum qumodes in combination with traditional quantum states to enhance channel security.

Aspect 10. A method for performing dynamic beam modulation for quantum authentication, comprising: (a) using a dynamic beam modulator to adjust properties of a quantum beam in real time; (b) encoding authentication data into the quantum beam through dynamic modulation; and (c) controlling modulation patterns to prevent eavesdropping.

Aspect 11. The method of aspect 10, wherein the modulation patterns are adjusted based on real-time network conditions or detected security threats.

Aspect 12. The method of aspect 10, wherein the dynamic beam modulator uses an adaptive algorithm to optimize modulation patterns.

Aspect 13. An anomaly detection mechanism for a quantum communication system, comprising: (a) a transmitter configured to: (i) prepare quantum states including vacuum states, near-vacuum states, and modulated quantum states; (ii) encode authentication data into the quantum states using dynamic modulation; (iii) transmit second states of entangled quantum state pairs through a quantum communication channel; and (iv) retain corresponding first states at the transmitter; (b) a measurement module at the transmitter configured to obtain quantum-state information from the retained first states; (c) a monitoring component configured to observe the quantum communication channel based on the quantum-state information derived from the first states; and (d) a real-time detection component configured to identify anomalies indicative of irreversible interactions affecting one or more second states during transmission through the quantum communication channel.

Aspect 14. The anomaly detection mechanism of aspect 13, wherein the detection component is configured to trigger threshold-based alerts in response to deviations from expected quantum-state statistics.

Aspect 15. The anomaly detection mechanism of aspect 13, further comprising redundant monitoring components configured to maintain continuous operation.

Aspect 16. A method for synchronizing timing and coordinating modulation in a quantum communication system, comprising: (a) utilizing synchronized time devices at a transmitter and a receiver to establish a shared time reference; (b) coordinating modulation patterns at the transmitter and the receiver based on the shared time reference; and (c) using the modulation patterns to encode, at the transmitter, and decode, at the receiver, a stream of quantum states each representing a second state of an entangled quantum state pair, the corresponding first state being retained at the transmitter for authentication.

Aspect 17. The method of aspect 16, wherein the synchronized time devices comprise atomic clocks that are periodically recalibrated to maintain timing precision.

Aspect 18. The method of aspect 16, wherein auxiliary timing signals are used to reduce timing drift between the transmitter and receiver.

Aspect 19. A method for secure quantum communication over multiple quantum channels, comprising: (a) establishing a plurality of quantum channels; (b) transmitting quantum states in parallel over the plurality of quantum channels using wavelength division multiplexing or another multiplexing technique; (c) applying a unique modulation pattern to each quantum channel; and (d) performing one-way quantum channel authentication for each quantum channel, comprising: (i) transmitting second states of entangled quantum state pairs through each quantum channel to a receiver; (ii) retaining corresponding first states at a transmitter; (iii) measuring quantum-state information of the retained first states; and (iv) determining whether one or more second states experienced an irreversible interaction during transmission.

Aspect 20. The method of aspect 19, wherein the quantum channels are multiplexed to increase both data throughput and channel-specific authentication granularity.

Aspect 21. The method of aspect 19, wherein the quantum channels are dynamically reallocated based on detected anomalies or security threats.

Aspect 22. The method of aspect 1, wherein encoding authentication data into the quantum states comprises: (a) using modulation constellations with a high number of distinguishable points within each modulation cluster; and (b) using two or more orthogonal modulation dimensions, the dimensions comprising at least two of quadrature, polarization, and frequency; wherein the increased constellation density and dimensionality increase the difficulty of successful eavesdropping by an adversary.

Aspect 23. A method for encoding authentication data into quantum states, comprising: (a) generating modulation patterns using one or more pattern generators; (b) encoding authentication data into quantum states using the generated modulation patterns; and (c) varying the modulation patterns over time to increase communication security.

Aspect 24. The method of aspect 23, wherein the pattern generators use cryptographic algorithms to generate the modulation patterns.

Aspect 25. The method of aspect 23, wherein the modulation patterns are periodically refreshed to reduce susceptibility to long-term correlation attacks.

Aspect 26. A method for decoding quantum states in a one-way quantum communication system, comprising: (a) synchronizing a time device at a receiver with a time device at a transmitter; (b) receiving, at the receiver, quantum states representing second states of entangled quantum state pairs; (c) decoding the received quantum states using a decoding modulation pattern derived from the synchronized time reference; and (d) measuring quantum-state information of the received quantum states; wherein the decoding modulation pattern is temporally correlated with a modulation pattern used to encode the quantum states at the transmitter.

Aspect 27. The method of aspect 26, further comprising applying an error correction algorithm to the measured quantum-state information to compensate for transmission noise or loss.

Aspect 28. The method of aspect 26, wherein the decoding system is configured to be resilient to quantum-based attacks.

Aspect 29. A system for quantum channel authentication, comprising: (a) a transmitter configured to: (i) prepare entangled quantum state pairs, each comprising a first state and a second state; (ii) apply dynamic modulation to encode authentication data into the quantum states; (iii) transmit the second states of the entangled pairs over a plurality of quantum channels; (iv) retain the first states at the transmitter; (b) synchronized timing devices at the transmitter and a receiver, configured to provide a shared time reference; (c) a measurement module at the transmitter configured to obtain quantum-state information from the first states; and (d) an anomaly detection subsystem configured to perform real-time analysis of quantum-state information to determine whether one or more second states underwent an irreversible interaction during transmission.

Aspect 30. The system of aspect 29, wherein each second state includes metadata for enhanced verification and monitoring.

Aspect 31. The system of aspect 29, wherein the anomaly detection subsystem is integrated with an external security system for comprehensive threat detection.

Aspect 32. A method for enhancing quantum communication security using decomposed qumodes, comprising: (a) preparing near-vacuum qumodes; (b) decomposing the near-vacuum qumodes into complex and unique quantum states using quantum operations; (c) encoding authentication data into the decomposed quantum states; (d) transmitting second states of entangled quantum state pairs corresponding to the decomposed quantum states through a quantum communication channel; (e) retaining first states at a transmitter; and (f) measuring quantum-state information of the first states to determine whether the corresponding second states underwent an irreversible interaction during transmission.

Aspect 33. The method of aspect 32, wherein the decomposed near-vacuum qumodes are periodically rotated in phase space to prevent pattern recognition by unauthorized parties.

Aspect 34. The method of aspect 32, wherein the decomposed quantum states are used in conjunction with advanced cryptographic techniques to provide dual-layer security.

Aspect 35. A system for continuous quantum channel authentication, comprising: (a) a transmitter configured to: (i) prepare and modulate entangled quantum state pairs comprising first and second states; (ii) transmit the second states through a quantum communication channel; (iii) retain the first states; and (iv) measure quantum-state information of the retained first states; (b) a monitoring subsystem configured to continuously monitor quantum-state information to identify deviations from expected values; (c) an anomaly detection mechanism configured to detect security anomalies based on quantum-state statistics; and (d) a feedback control mechanism configured to initiate a response when anomalies exceed a defined threshold.

Aspect 36. The system of aspect 35, wherein the monitoring subsystem includes predictive analytics configured to forecast potential security breaches.

Aspect 37. The system of aspect 35, wherein the monitoring subsystem is implemented in a decentralized configuration to enhance redundancy and resilience.

Aspect 38. A method for real-time anomaly detection in a quantum communication system, comprising: (a) preparing and modulating entangled quantum state pairs comprising first and second states; (b) transmitting the second states through a quantum communication channel and retaining the first states at a transmitter; (c) measuring quantum-state information of the retained first states; and (d) analyzing the measured quantum-state information using anomaly detection mechanisms to identify potential security breaches.

Aspect 39. The method of aspect 38, wherein the anomaly detection mechanisms are periodically updated to incorporate threat intelligence and evolving attack patterns.

Aspect 40. The method of aspect 38, wherein the anomaly detection mechanism includes self-healing logic to maintain system operation during partial disruption.

Aspect 41. A method for secure transmission of quantum states, comprising: (a) establishing multiple quantum communication channels; (b) preparing and modulating entangled quantum state pairs comprising first and second states; (c) assigning a unique modulation pattern to each channel; (d) transmitting the second states over the respective quantum channels while retaining the first states at a transmitter; and (e) performing one-way quantum channel authentication based on quantum-state information measured from the retained first states.

Aspect 42. The method of aspect 41, further comprising periodically revalidating each quantum channel to verify its continued integrity.

Aspect 43. The method of aspect 41, wherein the system includes failover mechanisms configured to reroute communication during channel degradation or failure.

Aspect 44. A system for one-way quantum channel authentication, comprising: (a) a transmitter and receiver each comprising a time synchronization device including atomic clocks; (b) a modulation subsystem configured to apply time-coordinated dynamic modulation patterns to entangled quantum states; (c) a decoding subsystem at the receiver configured to demodulate and interpret received second states; (d) a measurement module at the transmitter configured to collect quantum-state information from retained first states; and (e) an anomaly detection engine configured to detect unauthorized measurement or tampering based on analysis of the quantum-state information.

Aspect 45. The system of aspect 44, wherein the receiver includes a decryption module configured to extract embedded authentication data with improved fidelity.

Aspect 46. The system of aspect 44, wherein the transmitter and receiver are components of a multi-node quantum communication network.

Aspect 47. A method for quantum channel authentication using transformed quantum states, comprising: (a) applying one or more quantum operations to initial quantum states to generate transformed quantum states; (b) using the transformed quantum states to encode and transmit authentication data as part of entangled quantum state pairs; and (c) authenticating the transmission by analyzing quantum-state information of retained first states corresponding to the transmitted second states.

Aspect 48. The method of aspect 47, wherein the quantum operations include a quantum Fourier transform implemented using optimized quantum circuits.

Aspect 49. The method of aspect 47, wherein the transformed quantum states are periodically refreshed to maintain authentication reliability and avoid pattern inference.

Aspect 50. A method for authenticating a plurality of quantum communication channels using synchronized timing, comprising: (a) preparing entangled quantum state pairs, each comprising a first state and a second state; (b) transmitting the second states through a plurality of quantum channels while retaining the first states at a transmitter; (c) measuring quantum-state information from the retained first states; (d) using synchronized atomic clocks to ensure precise timing across the plurality of quantum channels; (e) coordinating time-based modulation and decoding patterns for each quantum channel; and (f) determining, based on the measured quantum-state information, whether one or more of the second states experienced irreversible interaction during transmission.

Aspect 51. The method of aspect 50, wherein the synchronized timing includes fallback synchronization methods to ensure continuous system operation.

Aspect 52. The method of aspect 50, wherein the plurality of quantum channels is managed using a centralized control system to enhance cross-channel coordination.

Aspect 53. A system for encoding and transmitting quantum authentication data, comprising: (a) one or more pattern generators configured to generate modulation patterns; (b) one or more dynamic beam modulators configured to encode authentication data into quantum states using the modulation patterns; (c) one or more transmission mechanisms configured to transmit second states of entangled quantum state pairs over multiple quantum communication channels; (d) a time synchronization subsystem configured to coordinate timing between the transmitter and receiver; (e) a measurement module at the transmitter configured to collect quantum-state information from the retained first states; and (f) an anomaly detection mechanism configured to detect unauthorized interference based on the quantum-state information.

Aspect 54. The system of aspect 53, wherein the pattern generators include adaptive algorithms configured to optimize modulation patterns based on real-time quantum-state information.

Aspect 55. The system of aspect 53, wherein the transmission mechanisms include error-checking protocols configured to ensure data integrity during quantum state transmission.

Aspect 56. A method for detecting anomalies in a quantum communication system, comprising: (a) preparing entangled quantum state pairs, each comprising a first state and a second state; (b) transmitting the second states through one or more quantum communication channels while retaining the first states at a transmitter; (c) using synchronized timing devices to coordinate the transmission and authentication process; (d) measuring quantum-state information from the retained first states; and (e) detecting anomalies based on deviations in the quantum-state information, without requiring feedback from the receiver.

Aspect 57. The method of aspect 56, wherein detecting anomalies comprises applying adaptive threshold settings that dynamically adjust in response to changing network conditions.

Aspect 58. A system for secure quantum communication, comprising: (a) a transmitter configured to: (i) prepare entangled quantum state pairs; (ii) retain the first states; (iii) encode authentication data into the second states using dynamic modulation; and (iv) transmit the second states through a quantum communication channel; (b) a receiver configured to receive the second states; (c) a time synchronization system comprising atomic clocks; (d) one or more pattern generators and beam modulators for encoding the authentication data; and (e) an anomaly detection mechanism configured to monitor quantum-state information and identify unauthorized measurement events or transmission interference.

Aspect 59. The system of aspect 58, wherein the system is designed to be compatible with emerging quantum communication standards and protocols.

Aspect 60. A method for one-way quantum channel authentication using quantum pings, comprising: (a) preparing entangled near-vacuum qumodes (NVQs), each comprising a first state and a second state; (b) transmitting the second state of each entangled NVQ through a quantum channel while retaining the corresponding first state at a transmitter; (c) using synchronized time devices to coordinate the timing of transmission across multiple quantum channels; (d) measuring quantum-state information from the retained first states; (e) continuously monitoring the integrity of the quantum channels based on statistical properties of the retained first states; and (f) implementing real-time anomaly detection mechanisms to identify potential security breaches.

Aspect 61. The method of aspect 60, wherein the entangled NVQs are modulated and decomposed to increase the complexity and security of the transmitted quantum states.

Aspect 62. The method of aspect 60, wherein the anomaly detection mechanism is integrated with a machine learning engine configured to adaptively respond to evolving threats.

Aspect 63. A method for authenticating a quantum communication channel using entangled quantum states, comprising: (a) generating a plurality of entangled quantum state pairs, each comprising a first quantum state and a second quantum state; (b) transmitting the second quantum state of each entangled pair through the quantum communication channel to a receiver; (c) retaining the first quantum state of each entangled pair at a transmitter; (d) modulating at least one property of the entangled quantum states based on a time-synchronized modulation pattern, the property including at least one of: amplitude, phase, polarization, or temporal delay; (e) measuring one or more observables of the retained first quantum states at the transmitter; and (f) accumulating measurement information over the plurality of entangled quantum state pairs to determine, with statistical significance, whether one or more of the second quantum states underwent an irreversible interaction during transmission through the quantum communication channel.

Aspect 64. The method of aspect 63, wherein measuring one or more observables comprises performing homodyne or heterodyne detection to obtain quadrature measurements. Claim 3 (Dependent—Modulation Techniques):

Aspect 65. The method of aspect 63, wherein the modulation pattern is derived from a shared time reference generated by an atomic clock or other time synchronization device. Claim 4 (Dependent—Authentication Criteria):

Aspect 66. The method of aspect 63, wherein an irreversible interaction is detected based on deviations in variance, entropy, or purity of the measured first quantum states.

Aspect 67. A transmitter device configured for quantum channel authentication using entangled quantum states, comprising: (a) a quantum light source configured to generate a plurality of entangled quantum state pairs, each comprising a first quantum state and a second quantum state; (b) a modulator configured to apply a time-varying modulation pattern to the entangled quantum states, the modulation pattern affecting at least one of: amplitude, phase, polarization, or temporal encoding; (c) a beam steering or optical coupling element configured to transmit the second quantum state of each entangled pair through a quantum communication channel; (d) a detection system configured to measure one or more observables of the retained first quantum state of each entangled pair; and (e) a processor or logic circuit configured to accumulate measurement data over multiple entangled quantum state pairs and determine whether the second quantum states traversed the quantum communication channel without undergoing irreversible interactions.

Aspect 68. The transmitter of aspect 67, wherein the detection system comprises a homodyne or heterodyne detector configured to measure quadrature components of the first quantum states.

Aspect 69. The transmitter of aspect 67, further comprising a time synchronization module including an atomic clock configured to control the modulation pattern applied by the modulator.

Aspect 70. The transmitter of aspect 67, wherein the processor is further configured to estimate a covariance matrix or compute statistical metrics including purity or entropy of the measured first quantum states.

Aspect 71. A method, comprising: synchronizing a first clock provided at a transmitter with a second clock provided at a receiver; determining, at the transmitter, a modulation pattern based on a signal from the first clock; generating, at the transmitter, an entangled quantum state including a first state entangled with a second state; modulating, at the transmitter, the entangled quantum state based on the modulation pattern; transmitting the second state through a channel to the receiver; measuring the first state at the transmitter to provide quantum-state information; and authenticating the channel based on a statistical analysis of the quantum-state information without measurement information of the second state.

Aspect 72. The method of aspect 71, wherein: modulating the entangled quantum state includes modulating the second state after the entangled quantum state has been generated.

Aspect 73. The method of any of aspects 71-72, wherein: modulating an unentangled states that is an input to an entanglement component that generates the entangled quantum state.

Aspect 74. The method of any of aspects 71-73, wherein: the quantum-state information is accumulated over a series of entangled quantum states to provide a statistically significant indication of whether a corresponding second state of each entangled pair traversed the channel without undergoing irreversible interactions including at least one of measurement-type decoherence events or environmental decoherence events.

Aspect 75. The method of any of aspects 71-74, wherein: modulating the entangled quantum state randomizes a frequency of the second state and randomizes at least one of a polarization, a quadrature angle, or an amplitude of the second state.

Aspect 76. The method of any of aspects 71-75, wherein: the first state and the second state of the entangled quantum state are near-vacuum qumodes of an optical field, and modulating the entangled quantum state includes applying at least one of a polarization modulation, an amplitude modulation, a phase modulation, or a quadrature modulation to the second state of the entangled quantum state.

Aspect 77. The method of any of aspects 71-76, wherein: the first clock is a first atomic clock, the second clock is a second atomic clock, and the first atomic clock and the second atomic clock are synchronized such that the modulation pattern matches a decoding pattern used at the receiver to demodulate the second state before measuring the second state to detect other quantum-state information.

Aspect 78. The method of aspect 77, further comprising: generating a secret key between the transmitter and the receiver based on the quantum-state information and the other quantum-state information.

Aspect 79. The method of aspect 78, further comprising: distilling a secret key from the quantum-state information using a quantum key distribution (QKD) process based on classical communications with the receiver and at least one of a key sifting and process, a security validation process, an error correction process, a privacy amplification process, or a classical channel authentication process.

Aspect 80. The method of any of aspects 71-79, wherein: the first state and the second state are respectively qumodes for continuous-variable quantum-information processing, and detecting the quantum-state information includes using homodyne detection or heterodyne detection to measure quadratures of the qumodes.

Aspect 81. The method of any of aspects 71-80, wherein: the first state and the second state are respectively qumodes for continuous-variable quantum-information processing, and authenticating the channel includes performing at least one of: (1) CV Gaussian tomography based on homodyne detection or heterodyne detection to generate an estimate of a covariance matrix as the quantum-state information; (2) a heterodyne certification protocol to generate a value of a state certification as the quantum-state information; or (3) classical shadow tomography to generate a value representing an expectation value, entropy, or fidelity as the quantum-state information.

Aspect 82. The method of any of aspects 71-81, wherein the quantum-state information indicates a degree to which the first state deviates from a pure state

Aspect 83. The method of any of aspects 71-82, wherein the transmitter delays measuring the first state until after a time for the second state to traverse the channel and be measured at the receiver.

Aspect 84. The method of any of aspects 71-83, wherein authenticating the channel further comprises: in response to detecting a compromise of the channel, refreshing a process used for determining the modulation pattern based on a signal from the first clock.

Aspect 85. The method of any of aspects 71-84, wherein authenticating the channel further comprises: analyzing fluctuations in one or more fields propagating through the channel to detect an anomaly, and determining that channel is compromised when the anomaly is detected.

Aspect 86. The method of any of aspects 71-85, further comprising: monitoring properties of the channel to determine real-time conditions of the channel; and dynamically adapting a quantum beam comprising a series of second states that are transmitted through the channel, the quantum beam being dynamically adapted to optimize transmission through the channel based on the real-time conditions of the channel.

Aspect 87. A communication system comprising: a transmitter that includes: a pattern generator that receives a signal from a clock and uses the signal to generate a modulation pattern, wherein the clock has been synchronized with a receiver clock that is located at a receiver; a quantum source that generates a series of entangled quantum states, an entangled quantum state including a first state entangled with a second state, the series of entangled quantum states including a series of second states that have been modulated based on the modulation pattern; an output coupler configured to transmit, through a channel to a receiver, a quantum beam comprising the series of second states; a detector configured to detect quantum-state information of the series of first states, which have been retained at the transmitter; and one or more processors configured to perform instructions that cause the one or more processors to: analyze the quantum-state information and thereby authenticate the channel.

Aspect 88. The communication system of aspect 87, wherein the instructions cause the one or more processors to authenticate the channel by: analyzing fluctuations in one or more fields propagating through the channel to detect an anomaly and determining that channel is compromised when the anomaly is detected.

Aspect 89. The communication system of any of aspects 87-88, wherein the instructions further cause the one or more processors monitor properties of the channel to determine real-time conditions of the channel; and dynamically adapt the quantum beam to optimize transmission through the channel based on the real-time conditions of the channel.

Aspect 90. The communication system of any of aspects 87-89, further comprising: the receiver that includes: a second pattern generator that generates a demodulation pattern based on a signal from the receiver clock; a demodulator that is configured to modulate received quantum states based on the demodulation pattern, the received quantum states being the second states received through the channel from the transmitter; and a receiver detector system that measures the received quantum states after processing through the demodulator to detect receiver quantum-state information.

Aspect 91. The communication system of any of aspects 87-90, wherein: the first state of the entangled quantum state is a first qumode, the second state of the entangled quantum state is a second qumode, the entangled quantum state includes the first qumode entangled with the second qumode, and the detector uses homodyne detection or heterodyne detection to measure quadratures of qumodes to detect the quantum-state information.

Aspect 92. The communication system of aspect 91, wherein the instructions further cause the one or more processors to: distill a secret key from the quantum-state information using a quantum key distribution (QKD) process based on classical communications between the receiver and the transmitter and at least one of a key sifting and process, a security validation process, an error correction process, a privacy amplification process, or a classical channel authentication process.

What is claimed is:

1. A method, comprising:
synchronizing a first timing device signal provided at a transmitter with a second timing device signal provided at a receiver;
determining, at the transmitter, a modulation pattern based on the first timing device signal;
generating, at the transmitter, an entangled quantum state including a first state entangled with a second state;
modulating, at the transmitter, the entangled quantum state based on the modulation pattern;
transmitting the second state through a channel to the receiver;
measuring the first state at the transmitter to provide quantum-state information; and
authenticating the channel based on a statistical analysis of the quantum-state information without measurement information of the second state.

2. The method of claim 1, wherein:
modulating the entangled quantum state includes modulating the second state after the entangled quantum state has been generated.

3. The method of claim 1, wherein:
modulating an unentangled states that is an input to an entanglement component that generates the entangled quantum state.

4. The method of claim 1, wherein:
the quantum-state information is accumulated over a series of entangled quantum states to provide a statistically significant indication of whether a corresponding second state of each entangled pair traversed the channel without undergoing irreversible interactions including at least one of measurement-type decoherence events or environmental decoherence events.

5. The method of claim 1, wherein:
the entangled quantum state comprises a first quantum state and a second quantum state and wherein modulating the entangled quantum state comprises utilizing a previously generated random pattern comprising at least one of a frequency, a phase, a polarization, or another quantum information correlation property.

6. The method of claim 1, wherein:
the first state and the second state of the entangled quantum state are near-vacuum qumodes of an optical field, and
modulating the entangled quantum state includes applying at least one of a polarization modulation, an amplitude modulation, a phase modulation, or a quadrature modulation to the second state of the entangled quantum state.

7. The method of claim 1, wherein:
the transmitter and the receiver each have access to the same time device signal and wherein the transmitter and the receiver time device signal are synchronized within a pre-determined tolerance in the time domain to ensure that the modulation pattern matches a decoding pattern used at the receiver to demodulate the second state before measuring the second state to detect other quantum-state information.

8. The method of claim 7, further comprising:
generating a secret key between the transmitter and the receiver based on the quantum-state information.

9. The method of claim 8, further comprising:
distilling a secret key from the quantum-state information using at least one of a key sifting technique, a security validation technique, an error correction technique, a privacy amplification technique, or a channel authentication technique.

10. The method of claim 1, wherein:
the first state and the second state are respectively qumodes for continuous-variable quantum-information processing, and
detecting the quantum-state information includes using homodyne detection or heterodyne detection to measure quadratures of the qumodes.

11. The method of claim 1, wherein:
the first state and the second state are respectively qumodes for continuous-variable (CV) quantum-information processing, and
authenticating the channel includes performing at least one of: (1) CV Gaussian tomography based on homodyne detection or heterodyne detection to generate an estimate of a covariance matrix as the quantum-state information; (2) a heterodyne certification protocol to generate a value of a state certification as the quantum-state information; or (3) classical shadow tomography to generate a value representing an expectation value, entropy, or fidelity as the quantum-state information.

12. The method of claim 1, wherein the quantum-state information indicates a degree to which the first state deviates from a pure state.

13. The method of claim 1, wherein the transmitter delays measuring the first state until after a time for the second state to traverse the channel and be measured at the receiver.

14. The method of claim 1, wherein authenticating the channel further comprises:
in response to detecting a compromise of the channel, refreshing a process used for determining the modulation pattern based on the first timing device signal.

15. The method of claim 1, wherein authenticating the channel further comprises:
analyzing fluctuations in one or more fields propagating through the channel to detect an anomaly, and
determining that channel is compromised when the anomaly is detected.

16. The method of claim 1, further comprising:
monitoring properties of the channel to determine real-time conditions of the channel; and
dynamically adapting a quantum beam comprising a series of second states that are transmitted through the channel, the quantum beam being dynamically adapted to optimize transmission through the channel based on the real-time conditions of the channel.

17. A communication system comprising:
a transmitter that includes:
a pattern generator that receives a signal from a time device and uses the signal to generate a modulation pattern, wherein the signal is synchronized with a receiver time device signal;
a quantum source that generates a series of entangled quantum states, an entangled quantum state including a first state entangled with a second state, the series of entangled quantum states including a series of second states that have been modulated based on the modulation pattern;
an output coupler configured to transmit, through a channel to a receiver, a quantum beam comprising the series of second states;
a detector configured to detect quantum-state information of the series of first states, which have been retained at the transmitter; and
one or more processors configured to perform instructions that cause the one or more processors to:
analyze the quantum-state information and thereby authenticate the channel.

18. The communication system of claim 17, wherein the instructions cause the one or more processors to authenticate the channel by:
analyzing fluctuations in one or more fields propagating through the channel to detect an anomaly, and
determining that channel is compromised when the anomaly is detected.

19. The communication system of claim 17, wherein the instructions further cause the one or more processors to:
monitor properties of the channel to determine real-time conditions of the channel; and
dynamically adapt the quantum beam to optimize signal quality of the transmission through the channel based on the real-time conditions of the channel.

20. The communication system of claim 17, further comprising:
the receiver that includes:
a second pattern generator that generates a demodulation pattern based on a signal from the receiver time device;
a demodulator that is configured to modulate received quantum states based on the demodulation pattern, the received quantum states being the second states received through the channel from the transmitter; and
a receiver detector system that measures the received quantum states after processing through the demodulator to detect receiver quantum-state information.

21. The communication system of claim 17, wherein:
the first state of the entangled quantum state is a first qumode,
the second state of the entangled quantum state is a second qumode,
the entangled quantum state includes the first qumode entangled with the second qumode, and
the detector uses homodyne detection or heterodyne detection to measure quadratures of qumodes to detect the quantum-state information.

22. The communication system of claim 21, wherein the instructions further cause the one or more processors to:
distill a secret key from the quantum-state information using at least one of a key sifting procedure, a security validation procedure, an error correction procedure, a privacy amplification procedure, or a channel authentication procedure.
